(19) United States
(12) Patent Application Publication
(10) Pub. No.: US 2022/0223967 A1
(43) Pub. Date: Jul. 14, 2022

(54) GALVANIC CELLS AND BATTERY MODULES

(71) Applicant: ElringKlinger AG, Dettingen (DE)

(72) Inventors: Steffen HELDMAIER, Bad Urach (DE); René Colin BEZLER, Ohmden (DE); Felix HAULER, Filderstadt (DE); Ulrich WERZ, Dettingen (DE); Chris SCHULZE, Aichtal (DE)

(73) Assignee: ElringKlinger AG, Dettingen (DE)

(21) Appl. No.: 17/585,391

(22) Filed: Jan. 26, 2022

Related U.S. Application Data
(63) Continuation of application No. PCT/EP2020/071268, filed on Jul. 28, 2020.

(30) Foreign Application Priority Data
Jul. 29, 2019 (DE) 10 2019 211 253.6

(51) Int. Cl. H01M 50/291; H01M 50/474; H01M 50/477

(52) U.S. Cl. CPC H01M 50/291; H01M 50/477; H01M 50/474

(57) ABSTRACT

Galvanic cells and/or battery modules comprising several galvanic cells, which have an increased service life and which are in particular easy and inexpensive to manufacture.

### RELATED APPLICATION

This application is a continuation of international application No. PCT/EP2020/071270 filed on Jul. 28, 2020, and claims the benefit of German application No. 10 2019 211 257.9 filed on Jul. 29, 2019, which are incorporated herein by reference in their entirety and for all purposes.

### FIELD OF DISCLOSURE

The present invention relates to galvanic cells and battery modules comprising galvanic cells.

Battery modules typically comprise one or more galvanic cells. Such galvanic cells are often subject to a swelling behavior that is based, among other things, on the one hand on aging effects and on the other hand on the intercalation and de-intercalation of ions in the electrodes of the galvanic cells.

### BACKGROUND

Growth of galvanic cells based on the aging thereof is based, for example, on gas formation due to chemical decomposition of the electrolyte of the galvanic cells and/or on the growth of an interface layer on the electrodes of the galvanic cells, which is referred to as the “solid electrolyte interphase” (SEI). In this case, winding layers of a cell winding of a galvanic cell can become detached from one another (which is referred to as “delamination”). A detachment of the winding layers of a cell winding can be caused, for example, by growth of the winding layers in a direction parallel to a stacking direction of a battery module and/or by growth of the winding layers in a direction perpendicular to a stacking direction of a battery module.

### SUMMARY OF THE INVENTION

The object of the present invention is to provide a galvanic cell and/or a battery module comprising several galvanic cells, which have in increased service life and which are in particular easy and inexpensive to manufacture.

This object is achieved by the features of the independent device claim.

Advantageous further developments are the subject matter of the dependent claims.

A galvanic cell according to the invention preferably comprises the following:
one or more cell windings;
a cell housing, which comprises a receiving space for receiving the one or more cell windings,

the one or more cell windings being received in the receiving space of the cell housing and the cell housing comprising or forming one or more spacer elements.

In particular, the cell housing in each case delimits a receiving space in which the one or more cell windings of a respective galvanic cell are received.

Within the scope of this description and the appended claims, the galvanic cells mentioned are in particular secondary cells.

The galvanic cells are thus preferably rechargeable galvanic cells.

In a battery module, in particular in a cell stack, a primary side of a galvanic cell and/or of a cell housing of the galvanic cell preferably faces a primary side of a further galvanic cell and/or a cell housing of the further galvanic cell.

A respective galvanic cell and/or a cell housing of a respective galvanic cell preferably comprises two primary sides and four secondary sides. Preferably, the two primary sides and/or two secondary sides are arranged on opposing sides of a respective galvanic cell and/or of a cell housing of a respective galvanic cell.

A primary side of a respective galvanic cell and/or of a cell housing of a respective galvanic cell is understood to mean, in particular, a side that has a larger surface area than the secondary sides of a respective galvanic cell and/or of a cell housing of a respective galvanic cell.

The galvanic cell preferably comprises one or more cell windings (“jelly rolls”).

For example, it is conceivable that the galvanic cell comprises two cell windings.

It can be favorable if the cell windings of the galvanic cell are arranged substantially parallel to one another.

Central planes of two cell windings arranged parallel to one another are preferably arranged parallel to one another.

A respective cell winding of the galvanic cell preferably comprises two deflection regions in which winding layers of the respective cell winding are deflected, the winding layers having a common winding line in a respective deflection region.

A winding direction of a respective cell winding preferably runs perpendicular to the common winding lines of the two deflection regions of the respective cell winding.

A winding layer preferably comprises a plurality of layers, for example two electrode layers and two separator layers.

It can be favorable if electrode layers and separator layers are each arranged alternately in a winding layer.

A layer sequence in a winding layer of a cell winding is therefore preferably as follows: separator layer, electrode layer, separator layer, electrode layer.

The electrode layers preferably comprise or are formed from an electrically conductive material, for example aluminum or copper.

The separator layers preferably comprise or are formed from an electrically insulating material, for example polyethylene and/or polypropylene.

Within the scope of this description and the appended claims, specifications relating to the arrangement of winding layers of a respective cell winding of galvanic cells relate in particular to a new state of a respective cell winding and/or a respective galvanic cell. In particular, it is conceivable that, over the service life of a galvanic cell or a battery module comprising a plurality of galvanic cells, slight deviations with regard to the arrangement of the winding layers can occur due to signs of aging.

The winding lines of the two deflection regions of a respective cell winding are preferably arranged substantially parallel to one another.

Cell windings of a galvanic cell are preferably formed axially symmetrically with respect to the common winding line in a deflection region.

In particular, it is conceivable that the winding layers of the respective cell winding are arranged substantially in a semicircle in a respective deflection region in a cross section taken perpendicularly to the common winding line.

It can be favorable if the common winding line of winding layers of the respective cell winding forms a common central point of semicircularly arranged winding layers of the cell winding in a respective deflection region of the cell winding in a cross section taken perpendicularly to the common winding line.

A respective cell winding of a galvanic cell comprises, in particular, a plurality of winding layers. Winding layers of the cell winding are preferably arranged substantially parallel to one another.

The cell winding preferably comprises a winding layer web that forms the winding layers. The winding layers are preferably formed by winding up the winding layer web.

In particular, it is conceivable that a single winding layer web comprises or forms all winding layers of a respective cell winding.

Winding layers of a respective cell winding are preferably arranged substantially parallel to a central plane of the cell winding in an intermediate region of the cell winding arranged between the two deflection regions of the cell winding.

It can be favorable if a cell winding comprises two deflection regions, each deflection region having a common winding line that is arranged in the central plane of the cell winding.

A stacking direction of a battery module preferably runs substantially perpendicular to a central plane of cell windings of the galvanic cells of the battery module.

It can be favorable if winding layers of a respective cell winding are arranged in the intermediate region of the cell winding substantially perpendicularly to a stacking direction of the battery module and/or parallel to a central plane of the cell winding.

In the respective deflection region of the cell winding, winding layers of the cell windings are preferably deflected, in particular by approximately 180°.

Cell windings of a galvanic cell of the battery module are preferably flat windings.

Within the scope of this description and the appended claims, a flat winding is understood to mean, in particular, a cell winding that comprises a plurality of winding layers that are deflected in two deflection regions, an intermediate region of the cell winding being arranged between the two deflection regions of the cell winding, in which intermediate region winding layers of the cell winding are arranged parallel to a central plane of the cell winding.

In one embodiment of the galvanic cell, it is provided that the cell housing of the galvanic cell comprises one or more spacer regions and a central region on a primary side of the cell housing, in particular on both primary sides of the cell housing, the one or more spacer regions protruding away from the central region perpendicular to a central plane of a cell winding of the galvanic cell and in each case forming a spacer element.

In particular, it can be provided that the cell housing of the galvanic cell comprises one or more transition regions on one primary side, in particular on both primary sides, that are arranged between the central region and the one or more spacer regions.

For example, it is conceivable that the one or more spacer regions comprise a surface that is arranged substantially parallel to a surface of the central region of a cell winding of the galvanic cell.

In one embodiment of the galvanic cell, it is provided that the one or more cell windings of the galvanic cell comprise two deflection regions in which winding layers of the respective cell winding are deflected, the winding layers having a common winding line in a respective deflection region, and/or that one or more cell windings of the galvanic cell comprise an intermediate region arranged between the two deflection regions.

In one embodiment of the galvanic cell, it is provided that a cell housing wall of the cell housing of the galvanic cell rests against the cell winding in the intermediate region of a cell winding of the galvanic cell.

In particular, it can be favorable if at least approximately 70%, in particular at least approximately 90%, of a surface of an intermediate region of a respective cell winding rests completely against the central region of the cell housing wall.

It can also be favorable if the central region of the cell housing wall rests substantially with its entire surface on an intermediate region of a respective cell winding.

For example, it is conceivable that a cell housing wall of the cell housing of a respective galvanic cell is arranged in the central region substantially parallel to a central plane of a cell winding of the galvanic cell.

In one embodiment of the galvanic cell, it is provided that a cell housing wall of the cell housing of the galvanic cell does not rest against the cell winding in the deflection region of a cell winding of the galvanic cell.

It can also be favorable if a cell housing wall of the cell housing of a respective galvanic cell does not rest against a cell winding of the galvanic cell in the one or more spacer regions and/or in the one or more transition regions.

Preferably, the cell housing wall of the cell housing of a respective galvanic cell is arranged in the one or more spacer regions substantially parallel to a central plane of a cell winding of the galvanic cell.

One or more spacer elements are formed in particular by one or more projections and/or elevations of a cell housing wall running perpendicular to the stacking direction and/or parallel to a central plane of a cell winding of the galvanic cell, which projections and/or elevations protrude away from the cell housing wall in the stacking direction of the battery module and/or perpendicular to the central plane of the cell winding.

In one embodiment of the galvanic cell, it is provided that the one or more spacer regions are arranged on an edge region, in particular on an edge region closed in a ring shape, of a respective primary side of the cell housing of a respective galvanic cell.

For example, it is conceivable that the central region of a respective primary side is surrounded by a spacer region that is closed in a ring shape.

In particular, the central region forms a depression in a primary side of the cell housing of the galvanic cell.

One or more spacer elements are arranged or formed in particular in a peripheral and/or ring-shaped closed edge region of cell housings of two adjacent galvanic cells.

The one or more spacer elements are preferably arranged or formed in an edge region of the mutually facing cell housing walls of the cell housings of two adjacent galvanic cells of a battery module, which cell housing walls are arranged in particular perpendicularly to the stacking direction of the battery module and/or parallel to a central plane of a cell winding of the galvanic cell.

For example, it is conceivable that a cell housing of a galvanic cell is designed to be substantially symmetrical, in particular substantially symmetrical with respect to a plane of symmetry arranged perpendicular to a stacking direction of a battery module and/or parallel to a central plane of a cell winding of a galvanic cell.

It can also be favorable if a cell housing of a galvanic cell is designed to be substantially symmetrical with respect to a plane of symmetry arranged parallel to a stacking direction of a battery module.

In one embodiment of the galvanic cell, it is provided that the cell housing of the galvanic cell is substantially concave on both primary sides.

In one embodiment of the galvanic cell, it is provided that the cell housing of the galvanic cell is substantially concave on a primary side and substantially convex on a primary side.

In one embodiment of the galvanic cell, it is provided that the cell housing of the galvanic cell comprises or is formed by a metallic material, for example aluminum.

The cell housing of the galvanic cell is preferably what is referred to as a “hard case” housing.

In particular, it can be favorable if the cell housing of the galvanic cell is produced by means of a forming process, for example by deep-drawing.

In particular, spacer elements formed by the cell housing of the galvanic cell are produced by means of a forming process.

A cell housing that is produced in a forming process, for example by means of deep-drawing, has, in particular, a substantially uniform wall thickness.

As an alternative to this, it is conceivable that the cell housing of the galvanic cell is produced by means of extrusion.

It can also be favorable if the cell housing of the galvanic cell is produced by means of an injection process, for example by means of an injection molding process, in particular from a plastic material.

A cell housing that is produced by means of extrusion or in an injection molding process can, in particular, also have an uneven wall thickness.

For example, it is conceivable that the cell housing of a respective galvanic cell is a plastic component, in particular a plastic injection molded component.

The galvanic cell according to the invention is in particular suitable for use in a battery module comprising two or more than two galvanic cells according to the invention.

In one embodiment of the battery module, it is provided that the cell housings of two adjacent galvanic cells are in direct contact with one another in the region of the spacer elements formed by the cell housing of the galvanic cells.

In particular, it can be favorable if the cell housings of two adjacent galvanic cells are only in direct contact with one another in some regions, in particular only in the region of the spacer elements formed by the cell housing of the galvanic cells.

Within the scope of this description and the appended claims, cell housings that are directly adjacent to one another are understood in particular to mean that the cell housing walls of the cell housings that are in direct contact with one another are either in direct material contact or that only an adhesive film and/or an insulation film is arranged between the two cell housings that are in direct contact with one another, which prevents direct material contact with the cell housing walls.

In one embodiment of the battery module, it is provided that the cell housings of two adjacent galvanic cells are designed in such a way that the cell housing walls of the two adjacent galvanic cells are arranged at a distance from one another by means of the spacer elements formed by the cell housing in an intermediate space that is closed at least in portions, preferably in a ring shape, and that is delimited by the spacer elements.

The cell housing walls of the two adjacent galvanic cells are preferably not in contact with one another in the intermediate space.

The central regions and/or the transition regions of a respective primary side of the cell housing of the two adjacent galvanic cells preferably delimit the intermediate space.

In particular, it is conceivable that the intermediate space is formed between two adjacent galvanic cells that are substantially concave on the mutually facing primary sides of the cell housings of the two adjacent galvanic cells.

Alternatively, it is conceivable that the intermediate space is formed between two adjacent galvanic cells, a first of the mutually facing primary sides of the cell housings of the two adjacent galvanic cells being substantially concave and a second of the mutually facing primary sides of the cell housings of the two adjacent galvanic cells being substantially convex.

One embodiment of the battery module provides that one or more additional elements are arranged in the intermediate space, for example one or more compensation elements, one or more propagation protection elements, one or more sensor elements and/or one or more temperature control elements.

For example, it is conceivable that sensor elements arranged in the intermediate space comprise or are formed by temperature sensors, expansion sensors and/or pressure sensors.

For example, a propagation protection element of a battery module comprises the following:
a phyllosilicate, in particular mica, vermiculite and/or expanded graphite;
basalt;
a ceramic material; and/or
a silicone mat having an endothermic filler.

A propagation protection element preferably has a thermal conductivity of at most approximately 1 W/m*K, in particular at most approximately 0.3 W/m*K, preferably at most approximately 0.1 W/m*K in a direction parallel to a stacking direction of a battery module.

It can be favorable if a propagation protection element has a heat resistance of at least approximately 600° C., for example a heat resistance of at least approximately 800° C.

By means of one or more temperature control elements arranged in the intermediate space, the galvanic cells adjacent to the intermediate space can preferably be temperature-controlled, for example cooled.

Heat can preferably be dissipated from the intermediate space by means of one or more temperature control elements arranged in the intermediate space.

The one or more temperature control elements arranged in the intermediate space are preferably designed for active temperature control of the galvanic cells adjacent to the intermediate space and/or for passive temperature control of the galvanic cells adjacent to the intermediate space.

Within the scope of this description and the appended claims, active temperature control is understood to mean, in particular, temperature control that is substantially based on convection, in particular on forced convection. Active temperature control is preferably implemented by a temperature control fluid flowing by means of external mechanical action, in particular by a temperature control liquid flowing by means of external mechanical action.

Within the scope of this description and the appended claims, passive temperature control is understood to mean, in particular, temperature control that takes place substantially by means of thermal conduction.

Propagation of a thermal runaway of a galvanic cell can preferably be delayed and/or prevented by means of one or more propagation protection elements arranged in the intermediate space.

Compensation elements are deformable, for example compressible, in a direction parallel to a stacking direction of a battery module, preferably due to an expansion of cell housings of two adjacent galvanic cells.

A delamination of cell windings of a respective galvanic cell can preferably be limited or prevented by means of one or more compensation elements.

The one or more compensation elements comprise or are formed by a foam material, for example.

In the delivered state of a battery module, the cell housings of two adjacent galvanic cells are preferably prestressed in the stacking direction of the battery module by means of compensation elements arranged in the intermediate space. In particular, a prestressing force can thereby be realized that preferably counteracts an expansion of the cell housings of the two adjacent galvanic cells, in particular due to aging.

One embodiment of the battery module provides that two adjacent galvanic cells are positioned or can be positioned in a unique alignment relative to one another in a stacking direction of the battery module by means of one or more spacer elements formed by the cell housing of the galvanic cells.

In particular, a positioning aid is formed by the spacer elements formed by the cell housing of the galvanic cells.

For example, it is conceivable that mutually facing cell housing walls of cell housings of two adjacent galvanic cells on the primary sides of the cell housing each comprise one or more projections or elevations designed as spacer elements and recesses corresponding to the projections or elevations.

It can be favorable if the projections or elevations and the recesses are arranged on the primary sides of the cell housings of two adjacent galvanic cells such that the galvanic cells can only be positioned in one orientation relative to one another in the stacking direction of the battery module.

A galvanic cell according to the invention preferably comprises the following:
one or more cell windings;
a cell housing comprising a receiving space for receiving the one or more cell windings;
one or more compensation elements,

the one or more cell windings being received in the receiving space of the cell housing and the one or more compensation elements being arranged in the receiving space of the cell housing.

In one embodiment of the galvanic cell, it is provided that the one or more compensation elements can be compressed, in particular perpendicularly to a primary side of the cell housing and/or perpendicularly to a central plane of a cell winding of the galvanic cell.

A swelling behavior of two adjacent galvanic cells can preferably be easily compensated for by means of the compensation elements arranged in the receiving space.

A plurality of galvanic cells, which comprise compensation elements arranged inside the cell housings of the galvanic cells, can thus preferably be easily installed in a stacking direction of a battery module, in particular easily clamped together.

A defined loading of one or more cell windings of a respective galvanic cell can preferably be implemented in any state of charge and/or in any state of aging of the galvanic cell.

In particular, one or more cell windings of a respective galvanic cell can be loaded independently of one or more of the following factors:
a stiffness of a cell housing of the galvanic cell;
clamping forces acting on the cell housing of the galvanic cell, in particular clamping forces acting on the cell housing parallel to a stacking direction of the battery module;
growth of one or more cell windings of the galvanic cell.

A primary side of the cell housing is arranged in a battery module, which comprises a plurality of galvanic cells, preferably perpendicular to a stacking direction of the battery module.

The one or more compensation elements are preferably elastically compressible. As an alternative to this, it is conceivable for the one or more compensation elements to be plastically compressible.

The one or more compensation elements can preferably be used to compensate for growth of the one or more cell windings of a galvanic cell over the service life of the galvanic cell, in particular in a direction perpendicular to a primary side of the cell housing of the galvanic cell.

Preferably, by means of the one or more compensation elements arranged in the cell housing of a galvanic cell, growth of the one or more cell windings of the galvanic cell can be compensated for in such a way that, at the end of the service life of the galvanic cell, a cell housing of the galvanic cell substantially has a height in a direction perpendicular to a primary side of the cell housing, which height corresponds to the height of the cell housing of the galvanic cell in a delivered state of the galvanic cell.

A change in the external dimensions of the galvanic cell due to growth of cell windings of the galvanic cells can preferably be limited or prevented due to one or more compensation elements arranged inside the cell housing of the galvanic cell.

In one embodiment of the galvanic cell, it is provided that, in a delivered state of the galvanic cell, the one or more compensation elements have a thickness perpendicular to a central plane of a cell winding of the galvanic cell such that the one or more compensation elements arranged inside the cell housing of the galvanic cell and the cell windings arranged inside the cell housing substantially completely fill a receiving space of the cell housing perpendicularly to the central plane of the cell winding of the galvanic cell.

In particular, cavities inside the cell housing, in particular parallel to a stacking direction of the battery module, can be prevented by means of one or more compensation elements arranged inside a cell housing of a respective galvanic cell.

A delamination of cell windings of a respective galvanic cell can thus preferably be limited or prevented.

An optimal operating state of the galvanic cell can preferably be set over the entire service life of said galvanic cell by means of one or more compensation elements arranged inside a cell housing of a respective galvanic cell.

In one embodiment of the galvanic cell, it is provided that the one or more compensation elements comprise a compressible material or are formed from a compressible material.

In one embodiment of the galvanic cell, it is provided that the compressible material is a foam material.

In one embodiment of the galvanic cell, it is provided that one or more of the compensation elements arranged in the receiving space of the cell housing are arranged between two adjacent cell windings of the galvanic cell.

In particular, one or more compensation elements arranged inside the cell housing of the galvanic cell are arranged in a stacking direction between two adjacent cell windings of the galvanic cell.

In one embodiment of the galvanic cell, it is provided that one or more of the compensation elements arranged in the receiving space of the cell housing are arranged between a cell housing wall of the cell housing and a cell winding of the galvanic cell, in particular in relation to a direction perpendicular to a central plane of the cell winding.

It can be favorable if one or more compensation elements arranged in the receiving space of the cell housing are arranged between a cell housing wall of a primary side of the cell housing and a cell winding of the galvanic cell.

One or more of the compensation elements arranged in the receiving space of the cell housing are arranged in particular between a cell housing wall of the cell housing extending perpendicular to a stacking direction of a battery module and a cell winding of the galvanic cell.

In one embodiment of the galvanic cell, it is provided that one or more compensation elements are arranged between the cell housing walls of two primary sides of the cell housing of the galvanic cell and one or more cell windings arranged inside the cell housing.

In particular, one or more compensation elements are arranged between a cell housing wall of a first primary side of the cell housing and a cell winding of the galvanic cell.

Furthermore, one or more compensation elements are preferably arranged between a cell housing wall of a second primary side of the cell housing and a cell winding of the galvanic cell.

In one embodiment of the galvanic cell, it is provided that a compensation element arranged between two adjacent cell windings of the galvanic cells and/or a compensation element arranged between a cell housing wall of the cell housing and a cell winding of the galvanic cell has a width parallel to a winding direction of the cell winding that at least approximately corresponds to the width of an intermediate region of the cell winding.

In one embodiment of the galvanic cell, one or more of the compensation elements arranged in the receiving space of the cell housing are arranged inside one or more cell windings of the galvanic cell.

Winding layers of a respective cell winding are preferably wound around a respective compensation element.

By winding winding layers of a respective cell winding around a respective compensation element, it is preferably possible to prevent the winding layers from being deflected directly in the region of a common winding line.

In particular, a deflection radius can be enlarged by winding winding layers of a respective cell winding around a respective compensation element.

A deflection radius in a deflection region of a cell winding is preferably at least approximately 0.5 mm, in particular at least approximately 1 mm, for example at least 1.5 mm.

In this way, a service life of the galvanic cell can preferably be lengthened.

In one embodiment of the galvanic cell, it is provided that a compensation element of the galvanic cell arranged inside a cell winding is arranged substantially parallel to a central plane of the respective cell winding.

In one embodiment of the galvanic cell, it is provided that a compensation element of the galvanic cell arranged inside a cell winding has a width parallel to a winding direction of the cell winding that substantially corresponds to the width of an intermediate region of the cell winding.

A compensation element of the galvanic cell arranged inside a cell winding preferably has a width parallel to the winding direction of the cell winding that at most corresponds approximately to the width of an intermediate region of the cell winding.

In particular, it is conceivable that one or more compensation elements are arranged inside all cell windings of a respective galvanic cell.

Preferably, by means of one or more compensation elements arranged inside one or more cell windings of the galvanic cell, growth of a respective cell winding, in particular in a direction perpendicular to a central plane of a cell winding, can be compensated for in such a way that, at the end of its service life, the galvanic cell substantially has a height in the direction perpendicular to a central plane of the cell winding, which height corresponds to the height of the galvanic cell in a delivered state of the galvanic cell.

In one embodiment of the galvanic cell, it is provided that one or more of the compensation elements arranged in the receiving space of the cell housing have a height in a direction parallel to a common winding line of a cell winding, which height substantially corresponds to a height of the one or more cell windings of the galvanic cell.

The one or more cell windings of the galvanic cell preferably each have a substantially identical height in a direction parallel to a common winding line of a cell winding.

The galvanic cell according to the invention is in particular suitable for use in a battery module comprising two or more than two galvanic cells according to the invention.

A battery module according to the invention preferably comprises the following:
two or more than two galvanic cells, each comprising one or more cell windings;
one or more spacer elements, in each case one or more spacer elements being arranged between two adjacent galvanic cells.

It can be favorable if a battery module forms an accumulator module.

The galvanic cells of the battery module are preferably arranged along a stacking direction.

Galvanic cells of the battery module arranged along a stacking direction form, in particular, a cell stack.

It can be favorable if the galvanic cells of the battery module are arranged in alignment with one another along the stacking direction.

One or more spacer elements are in each case preferably arranged between mutually facing cell windings of two galvanic cells adjacent to one another in a stacking direction.

The galvanic cells are preferably arranged next to one another in a stacking direction with a primary side thereof and/or with a primary side of a cell housing of a respective galvanic cell.

Mutually facing cell windings of two adjacent galvanic cells are preferably arranged at a distance from one another by means of one or more spacer elements, in particular in a stacking direction.

A predetermined distance between the two adjacent galvanic cells can preferably be adjusted by means of one or more spacer elements arranged between two adjacent galvanic cells.

It can be favorable if, by means of the one or more spacer elements, an expansion of a respective galvanic cell, in particular of a cell housing of the respective galvanic cell, which expansion is due to gas formation as a result of chemical decomposition of the electrolyte of the galvanic cell, can be substantially prevented and if an expansion of a respective galvanic cell, in particular of a cell housing of the respective galvanic cell, which expansion is based on growth of the one or more cell windings of the galvanic cell, is nevertheless permitted.

It is preferably conceivable that delamination of cell windings of the galvanic cell can be prevented due to the limitation of an expansion of a respective galvanic cell, which expansion is due to gas formation. In particular, aging of the galvanic cell can be delayed.

A pressure on cell windings of a respective galvanic cell of the battery module can preferably be reduced by means of the one or more spacer elements, preferably in the region of the common winding lines of two deflection regions of a cell winding. In particular, a drop in capacity of the galvanic cells of the battery module can be reduced. It can also be favorable if mechanical overstressing of the cell windings of the galvanic cells is avoided by means of the one or more spacer elements.

In one embodiment of the battery module, it is provided that a respective cell winding of the galvanic cells of the battery module comprises two deflection regions in which winding layers of the respective cell winding are deflected, the winding layers having a common winding line in a respective deflection region.

In one embodiment of the battery module, it is provided that the one or more spacer elements are each arranged and/or designed in such a way that, in a stacking direction of the battery module, the spacer elements can be used to avoid the introduction of force into the one or more cell windings of a respective galvanic cell, in particular in the region of a winding line of a respective deflection region of the one or more cell windings.

The one or more spacer elements can be used to direct a force flux in a stacking direction of the battery module in such a way that preferably no force is exerted in the stacking direction on a winding line of a respective deflection region of the one or more cell windings.

In one embodiment of the battery module, it is provided that a force flows between adjacent galvanic cells in a stacking direction of the battery module exclusively or to an extent of at least approximately 75%, in particular to an extent of at least approximately 85%, preferably to an extent of at least approximately 95%, via the one or more spacer elements.

In one embodiment of the battery module, it is provided that the galvanic cells are prismatic cells, in particular substantially cuboid cells.

In particular, it is conceivable that the galvanic cells are designed according to the PHEV2 format.

It can be favorable if a cell housing of a respective galvanic cell is prismatic, in particular substantially cuboid.

In one embodiment of the battery module, it is provided that a respective galvanic cell comprises a cell housing in which the one or more cell windings of a respective galvanic cell are arranged.

In one embodiment of the battery module, it is provided that one or more spacer elements are arranged between the cell housings of two adjacent galvanic cells.

In particular, one or more spacer elements are arranged between mutually facing cell housing walls of cell housings of two adjacent galvanic cells.

For example, provision can be made for a plurality of spacer elements to be arranged one behind the other in a stacking direction of the battery module between the cell housings of two adjacent galvanic cells.

As an alternative to this, it is conceivable for only a single spacer element to be arranged between the cell housings of two adjacent galvanic cells in a stacking direction of the battery module.

It can also be favorable if a plurality of spacer elements are arranged next to one another and perpendicular to a stacking direction of the battery module.

For example, it is conceivable that one or more spacer elements are applied, for example sprayed, onto a cell housing of one of the two adjacent galvanic cells by means of an application device. It can also be favorable if one or more spacer elements are applied to, for example sprayed onto, both cell housings of the two adjacent galvanic cells by means of an application device.

In particular, it is conceivable for spacer elements, which comprise or are formed from a plastic material, for example silicone and/or polyurethane, to be applied to the cell housing by means of the application device.

It is conceivable, for example, for a bump and/or knobs made of a plastic material to be applied to, for example sprayed onto, the cell housing as spacer elements by means of the application device.

In particular, it is conceivable that plastic material applied to the cell housing by means of the application device is applied directly or indirectly to the cell housing.

Plastic material applied indirectly to the cell housing is applied in particular to an insulation film that is applied directly to a cell housing wall of the respective cell housing and/or connected thereto.

In one embodiment of the battery module, it is provided that one or more spacer elements, which are arranged between cell housings of two adjacent galvanic cells, are arranged on a primary side of the respective cell housing.

In one embodiment of the battery module, it is provided that one or more spacer elements arranged between two cell housings of two adjacent galvanic cells each comprise or form a frame element and/or an intermediate element.

In one embodiment of the battery module, it is provided that a respective frame element delimits an interior space surrounded by the frame element and the two adjacent cell housings at least in some regions, for example at least on two sides.

By means of a frame element of a respective spacer element, a predetermined distance can preferably be fixed between two adjacent galvanic cells, in particular on an edge region of mutually facing primary sides of the respective cell housings of the galvanic cells.

For example, it is conceivable that precisely one frame element is arranged between two cell housings of two adjacent galvanic cells.

For example, it can be favorable if a respective frame element surrounds the intermediate space on at least three sides. For example, it is conceivable that a respective frame element is substantially U-shaped.

In one embodiment of the battery module, it is provided that a respective frame element comprises the following:
two supporting webs, which are arranged parallel to one another and/or parallel to a common winding line of a deflection region of a cell winding of a galvanic cell; and/or
one or more connecting webs, the two supporting webs being connected by means of the one or more connecting webs.

Supporting webs and/or connecting webs of a respective frame element preferably run along an edge region of a respective primary side of the two adjacent cell housings.

Preferably, supporting webs and/or connecting webs of the frame element do not have any sharp edges on a side of the frame element that is in contact with a cell housing.

In particular, it can be provided that edges of supporting webs and/or connecting webs of the frame element are rounded on a side of the frame element that rests against a cell housing.

Stress peaks and/or edge imprints on the cell housing can preferably be avoided.

In one embodiment of the battery module, it is provided that a respective frame element is closed in a ring shape.

A frame element closed in a ring shape preferably comprises two supporting webs and two connecting webs.

The two supporting webs are preferably arranged substantially parallel to one another.

In one embodiment of the battery module, it is provided that the two supporting webs and/or the one or more connecting webs have a substantially constant width transverse, in particular perpendicular, to a main direction of extent thereof.

As an alternative to this, it is possible for the two supporting webs and/or the one or more connecting webs to have a width that varies transversely, in particular perpendicularly, to a main direction of extent thereof.

In particular, an inner profile of the frame element can be adapted to a swelling behavior of the two adjacent galvanic cells.

A main direction of extent of the two supporting webs and/or the one or more connecting webs runs, in particular, perpendicularly to a stacking direction of the battery module.

A main direction of extent of the two supporting webs preferably runs parallel to a common winding line of a deflection region of a cell winding of a galvanic cell.

In one embodiment of the battery module, it is provided that the width of the two supporting webs substantially corresponds to the width of the one or more connecting webs.

In one embodiment of the battery module, it is provided that the width of the two supporting webs differs from the width of the one or more connecting webs.

It can be favorable, for example, if the width of the one or more connecting webs is greater by a factor of at least approximately 1.5 than the width of the two supporting webs, for example by a factor of at least approximately 2.

In one embodiment of the battery module, it is provided that the width of the two supporting webs corresponds approximately to the sum of a wall thickness of a cell housing wall of a cell housing of a galvanic cell, a distance between a cell winding and the cell housing wall of the cell housing and a width of a deflection region of a cell winding.

The aforementioned dimensions preferably relate to a direction parallel to a winding direction of a cell winding and/or perpendicular to a stacking direction of the battery module.

A width of a deflection region of a cell winding preferably corresponds substantially to half a thickness of a cell winding parallel to a stacking direction of the battery module.

In one embodiment of the battery module, it is provided that a projection of a respective supporting web of a frame element, in particular a region of the supporting web abutting a cell housing of a galvanic cell, along the stacking direction onto a projection plane arranged perpendicular to the stacking direction is at a distance from a projection of a respective common winding line of a deflection region of a cell winding of a galvanic cell.

Preferably, the projection of the supporting web, in particular of the region of the supporting web abutting the cell housing, is at a distance, in particular outward, from the projection of the common winding line in a direction parallel to a winding direction.

The projection of the region of the supporting web that abuts the cell housing preferably does not overlap the projection of the common winding line.

It can also be favorable if a projection of an intermediate element along the stacking direction onto a projection plane arranged perpendicular to the stacking direction is at a distance from a projection of a respective common winding line of a deflection region of a cell winding of a galvanic cell.

The projection of the intermediate element is preferably at a distance, in particular inward, from the projection of the common winding line in a direction parallel to a winding direction.

In one embodiment of the battery module, it is provided that the supporting webs of the frame element and/or the connecting webs of the frame element have a constant thickness in a direction parallel to a stacking direction of the battery module.

In one embodiment of the battery module, it is provided that the supporting webs of the frame element and/or the connecting webs of the frame element have a locally varying thickness in a direction parallel to a stacking direction of the battery module.

For example, it is conceivable that the supporting webs and/or the connecting webs of the frame element have a first thickness in corner regions in which the supporting webs and the connecting webs are connected to one another.

The supporting webs and/or the connecting webs of the frame element preferably have a second thickness between two corner regions in each case.

The first thickness can, in particular, be greater than the second thickness, for example by a factor of 2.

A maximum thickness of the frame element, in particular of the supporting webs and/or the connecting webs, parallel to a stacking direction of the battery module preferably corresponds to at least approximately 5%, in particular at least approximately 7.5%, for example at least approximately 10%, of a height of a cell housing of the galvanic cell in the stacking direction.

If the supporting webs and/or the connecting webs of the frame element have a greater thickness in corner regions than outside the corner regions, a force can flow between adjacent galvanic cells in a stacking direction substantially via particularly rigid regions of the cell housings of the galvanic cells.

In one embodiment of the battery module, it is provided that the intermediate element is arranged in the interior space.

It can be favorable if the intermediate element is arranged completely in the interior space.

For example, it is conceivable that the intermediate element fills the interior space in a direction perpendicular to a stacking direction of the battery module to an extent of at least approximately 50%, for example to an extent of at least approximately 75%, preferably to an extent of at least approximately 95%, in particular completely.

Alternatively, it is conceivable that the intermediate element is only in part arranged in the interior space. The frame element and the intermediate element preferably overlap at least in part in the stacking direction.

For example, it is conceivable that the intermediate element completely overlaps the frame element, with the exception of corner regions in which supporting webs and connecting webs of a frame element are connected to one another. The intermediate element preferably forms a compensation element that can be compressed parallel to a stacking direction of the battery module.

It can also be favorable if the spacer element does not comprise or form an intermediate element.

For example, it is conceivable that only gas, for example air, is arranged in the interior space.

It can also be favorable if one or more additional elements are arranged in the interior space, for example one or more compensation elements, one or more propagation protection elements, one or more sensor elements and/or one or more temperature control elements.

In one embodiment of the battery module, it is provided that the frame element is designed in one or more parts, for example in two parts.

A multi-part frame element comprises, for example, a plurality of frame element parts.

It can be favorable if frame element parts can be connected to one another in a force-fitting and/or form-fitting manner, for example by means of a plug-in connection.

By means of a plug-in connection, for example, two L-shaped frame element parts can be connected to one another in a force-fitting and/or form-fitting manner, in particular for the production of a frame element closed in a ring shape.

For example, it is conceivable that the frame element comprises only two supporting webs. In each case, a supporting web preferably forms a frame element part.

It can also be favorable if the frame element comprises two frame element parts that are substantially T-shaped in a cross section taken perpendicularly to a common winding line of a deflection region of a cell winding of a galvanic cell.

In one embodiment of the battery module, it is provided that two spacer elements, in particular two frame elements, are arranged between the cell housings of two adjacent galvanic cells.

A spacer element is preferably arranged on the cell housing of the two adjacent galvanic cells on opposing primary sides of a cell housing of a respective galvanic cell.

Parallel to a stacking direction of the battery module, a sequence is preferably as follows: spacer element, galvanic cell, spacer element, spacer element, galvanic cell, spacer element, spacer element, galvanic cell, spacer element, spacer element, galvanic cell, etc.

In particular, two frame elements are in each case slipped onto a galvanic cell, in particular onto the cell housing of the galvanic cell.

The two frame elements enclose the respective galvanic cell, in particular the cell housing of the galvanic cell, in each case at least approximately in a C-shape.

The two frame elements preferably each comprise an at least approximately C-shaped receiving portion, in which a cell housing of a galvanic cell is at least in part received parallel to a stacking direction of the battery module.

The two frame elements preferably each comprise two supporting webs and two connecting webs. The two frame elements are preferably closed in a ring shape.

In particular, it can be provided that the two frame elements preferably each comprise two or more than two, for example four, fastening projections that protrude away from the two supporting webs and/or the two connecting webs parallel to a stacking direction of the battery module.

In each case, one fastening projection, in particular a fastening web, preferably protrudes away from a supporting web and/or from a connecting web parallel to a stacking direction of the battery module.

A length of the fastening webs preferably substantially corresponds to a length of the supporting webs and/or connecting webs, in particular parallel to a main direction of extent of the supporting webs and/or connecting webs.

The fastening projections and/or fastening webs preferably surround a cell housing on four sides.

In one embodiment of the battery module, it is provided that the frame element is connected to the intermediate element at least in some regions, in particular integrally.

For example, it is conceivable that the frame element is made in one piece with the intermediate element.

A spacer element, which comprises or forms the frame element and the intermediate element, is, for example, a one-piece injection molded component.

For example, it is conceivable that the intermediate element is connected to the frame element only in the region of two supporting webs of said frame element.

It can be favorable if the intermediate element is not connected to the frame element in the region of two connecting webs of said frame element.

Alternatively, it is conceivable that the intermediate element is connected to the frame element closed in a ring shape. In particular, the intermediate element forms a cover element.

An intermediate element that forms a cover element has a constant thickness parallel to a stacking direction, for example. An intermediate element that forms a cover element preferably has a smaller thickness than a frame element parallel to a stacking direction.

In particular, it is conceivable that the spacer element has material weakening in a connection region in which the frame element is integrally connected to the intermediate element.

As an alternative or in addition to an integral connection of the frame element and the intermediate element, it is conceivable that the frame element and the intermediate element are connected to one another in a force-fitting and/or form-fitting manner.

Alternatively, it is conceivable that the frame element is not connected to the intermediate element.

In one embodiment of the battery module, it is provided that the frame element and the intermediate element comprise materials that differ from one another or are formed from materials that differ from one another.

In one embodiment of the battery module, it is provided that the intermediate element forms a deformable compensation element.

For example, it is conceivable that an intermediate element designed as a deformable compensation element comprises or is formed from a rubber material.

In one embodiment of the battery module, it is provided that the compensation element can be compressed parallel to a stacking direction of the battery module.

An intermediate element designed as a compressible compensation element comprises in particular a compressible material, for example a foam material, or is formed therefrom.

The compressible material of an intermediate element designed as a compressible compensation element is, for example, elastically or plastically compressible.

An intermediate element designed as a compressible compensation element has, for example, a maximum thickness parallel to a stacking direction of the battery module when it is new, which thickness corresponds to a maximum thickness of the frame element.

Alternatively, it is conceivable that an intermediate element designed as a compressible compensation element is prestressed between two adjacent cell housings parallel to the stacking direction of the battery module in the delivered state of the battery module.

For example, it is conceivable that an intermediate element designed as a compressible compensation element is of multi-layer design in the stacking direction. In particular, the intermediate element designed as a compensation element can be adapted to a swelling behavior of two adjacent galvanic cells.

In one embodiment of the battery module, it is provided that the compensation element comprises one or more deformation elements.

For example, it is conceivable that the intermediate element designed as a deformable compensation element comprises one or more deformation webs, which form the deformation elements.

It can be favorable if a deformation web has a U-shaped or V-shaped cross section.

In particular, it is conceivable that a deformation web of an intermediate element designed as a deformable compensation element is connected to two connecting webs of a frame element.

Deformation webs of an intermediate element designed as a deformable compensation element are preferably arranged substantially parallel to the supporting webs of the frame element.

It can also be favorable if the intermediate element designed as a deformable compensation element comprises a plurality of deformable knobs that form the deformation elements.

The deformable knobs are preferably substantially circular-cylindrical.

The deformable knobs preferably protrude away from a base plate parallel to a stacking direction of the battery module, in particular on both sides of the base plate.

Individual or multiple deformable knobs preferably have a different cross-sectional shape and/or a different diameter from one another, in particular in a cross section taken perpendicularly to a stacking direction of the battery module.

It can be favorable if the deformable knobs are arranged in a plurality of rows and/or a plurality of columns.

For example, it is conceivable that deformable knobs arranged in a column each have an identical cross-sectional shape and/or an identical diameter.

Furthermore, it is conceivable, for example, that one or more deformable knobs arranged in a row have a different cross-sectional shape and/or a different diameter from one another.

The intermediate element designed as a deformable compensation element can preferably be adapted to a swelling behavior of the two adjacent galvanic cells.

In particular, a deformation resistance of the deformable knobs can be adjusted by adjusting a diameter of said deformable knobs.

In one embodiment of the battery module, it is provided that an edge region of a spacer element, in particular an edge region that is closed in a ring shape, is of multi-layer design, the multi-layer edge region forming a frame element.

In particular, it is conceivable that the spacer element comprises a compressible material, for example a foam material.

The compressible material is, for example, elastically or plastically compressible.

It can be favorable if the compressible material in the multi-layer edge region is consolidated by means of leveling and/or compacting.

In one embodiment of the battery module, it is provided that a respective spacer element, in particular a respective frame element and/or a respective intermediate element, comprises or is formed from a metallic material, a paper material or a plastic material.

For example, it is conceivable that a respective spacer element, in particular a respective frame element and/or a respective intermediate element, comprises or is formed from silicone or polyurethane.

It can also be favorable if a respective spacer element, in particular a respective frame element and/or a respective intermediate element, comprises or is formed from a fiber-reinforced plastic material, for example glass-fiber-reinforced polybutylene terephthalate (PBT) or glass-fiber-reinforced polypropylene (PP).

Alternatively, it is conceivable that a respective spacer element, in particular a respective frame element and/or a respective intermediate element, comprises or is formed from a foam material.

In one embodiment of the battery module, it is provided that a force flows between adjacent galvanic cells in a stacking direction of the battery module exclusively or to an extent of at least approximately 75%, in particular to an extent of at least approximately 85%, preferably to an extent of at least approximately 95%, via the frame element of the one or more spacer elements.

A force flux in a stacking direction of the battery module thus preferably takes place substantially via the frame elements.

It can be favorable if galvanic cells of the battery module are braced along a stacking direction.

For example, it can be provided that all galvanic cells of the battery module are arranged in a stacking direction between two end plates, the two end plates being braced along the stacking direction by means of one or more clamping elements, which are known as “tie rods.”

In one embodiment of the battery module, it is provided that a spacer element, in particular a frame element, arranged between the cell housings of two adjacent galvanic cells is in each case integrally connected, in particular bonded, to the cell housings of the two adjacent galvanic cells.

It is particularly conceivable here for the frame element to be integrally connected, in particular bonded, to an electrical insulation film that is applied directly to a cell housing wall of the cell housing and/or connected thereto.

Alternatively or in addition to an integral connection of the spacer element, in particular the frame element, arranged between the cell housings of two adjacent galvanic cells, a force-fitting and/or form-fitting connection with one of the two cell housings can also be provided.

For example, it is conceivable that the spacer element, in particular the frame element, arranged between two adjacent galvanic cells is connected to one of the two cell housings in a force-fitting and/or form-fitting manner by means of an electrical insulation film, for example by the spacer element, in particular the frame element, being secured to the cell housing by wrapping the cell housing with the electrical insulation film.

If the spacer element, in particular the frame element, is connected to one of the two cell housings in a force-fitting and/or form-fitting manner by means of an electrical insulation film, provision can be made for the spacer element, in particular the frame element, to be temporarily fastened to a cell housing wall of the cell housing, for example by means of an adhesive material, before the electrical insulation film is wrapped around the cell housing.

In one embodiment of the battery module, it is provided that the spacer element, in particular a frame element of the spacer element, arranged between the cell housings of two adjacent galvanic cells is in each case bonded to the cell housings of the two adjacent galvanic cells by means of an adhesive film arranged between a primary side of a cell housing of a respective galvanic cell and the spacer element, in particular the frame element.

In particular, it can be favorable if the adhesive film forms a propagation protection element.

In one embodiment of the battery module, it is provided that all spacer elements of the battery module arranged between two cell housings of two adjacent galvanic cells are identical.

All frame elements arranged between two cell housings of two adjacent galvanic cells are preferably of identical design.

In one embodiment of the battery module, it is provided that the frame element and/or the intermediate element each comprise or form a temperature control element.

The frame element and/or the intermediate element are preferably designed for active temperature control and/or for passive temperature control.

By means of the frame element and/or by means of the intermediate element, heat can preferably be dissipated from the two adjacent galvanic cells between which the spacer element is arranged.

It can also be favorable if the two adjacent galvanic cells, between which the spacer element is arranged, can be supplied with heat by means of the frame element and/or by means of the intermediate element.

It can be favorable if the frame element and/or the intermediate element each comprise one or more heat-conducting elements that protrude away from the frame element and/or the intermediate element in a stacking direction of the battery module.

For example, it is conceivable that the spacer element, in particular the frame element and/or the intermediate element, has an anisotropic thermal conductivity.

A thermal conductivity of the spacer element, in particular of the frame element and/or the intermediate element, in a stacking direction of the battery module is preferably less than a thermal conductivity of said spacer element perpendicular to the stacking direction of the battery module.

The spacer element, in particular the frame element and/or the intermediate element, is preferably designed as a heat insulator in a stacking direction of the battery module.

It can also be favorable if the spacer element, in particular the frame element and/or the intermediate element, is designed as a heat conductor perpendicular to a stacking direction of the battery module.

In one embodiment of the battery module, it is provided that the battery module comprises a battery module housing in which the galvanic cells of the battery module are arranged.

The battery module according to the invention preferably has one or more of the features and/or advantages described in connection with the galvanic cells according to the invention.

The galvanic cells according to the invention preferably also have one or more of the features and/or advantages described in connection with the battery module according to the invention.

The present invention also relates to a method for attaching spacer elements to a galvanic cell.

The present invention is based on the further object of providing a method for attaching spacer elements to a galvanic cell, by means of which method spacer elements can be attached to a galvanic cell in a simple and cost-effective manner.

This object is achieved by the features of the independent method claim.

The method for attaching spacer elements to a galvanic cell preferably comprises the following:
providing a galvanic cell comprising one or more cell windings;
applying one or more spacer elements made of a castable, injectable and/or printable material to a cell housing of the galvanic cell.

In one embodiment of the method for attaching spacer elements to a galvanic cell, it is provided that the one or more spacer elements are applied to the cell housing of the galvanic cell by means of one or more of the following application methods:
by means of a casting process;
by means of an injection process;
by means of a printing process.

The casting process is, for example, a slip casting process or a film casting process.

In one embodiment of the method for attaching spacer elements to a galvanic cell, it is provided that the one or more spacer elements are applied to the cell housing of the galvanic cell by means of one or more of the following printing processes:
by means of a screen printing process;
by means of a stencil printing process.

In one embodiment of the method for attaching spacer elements to a galvanic cell, it is provided that the castable, injectable and/or printable material comprises a base material and spacer particles arranged in the base material.

The spacer particles are preferably applied to the cell housing of the galvanic cell together with the base material.

The spacer particles are substantially spherical in shape, for example.

It can be favorable if the spacer particles have a diameter within the range of approximately 0.5 mm to approximately 1.5 mm.

For example, it is conceivable that the spacer particles are glass beads.

The spacer particles preferably have a higher compressive strength than the base material.

In one embodiment of the method for attaching spacer elements to a galvanic cell, it is provided that one or more propagation protection elements and/or one or more compensation elements made of a castable, injectable and/or printable material are applied to the cell housing of the galvanic cell.

In one embodiment of the method for attaching spacer elements to a galvanic cell, it is provided that the one or more spacer elements are applied to the cell housing of the galvanic cell using an application device.

It can be favorable if the application device comprises an application nozzle, through which injectable and/or printable material can be applied to the cell housing of the galvanic cell.

The application device preferably also comprises a conveying device, by means of which the injectable and/or printable material can be fed to an application nozzle of the application device.

The conveying device is, for example, a gear metering device.

In one embodiment of the method for attaching spacer elements to a galvanic cell, it is provided that the one or more spacer elements are applied to the cell housing of the galvanic cell with a locally varying thickness.

In one embodiment of the method for attaching spacer elements to a galvanic cell, it is provided that the one or more spacer elements are attached directly or indirectly to the cell housing of the galvanic cell.

If the one or more spacer elements are applied directly to the cell housing of the galvanic cell, they are in particular applied directly to a cell housing wall of the cell housing.

If the one or more spacer elements are applied directly to the cell housing of the galvanic cell, they are preferably applied to an electrical insulation film arranged on a cell housing wall of the cell housing.

In one embodiment of the method for attaching spacer elements to a galvanic cell, it is provided that a plurality of layers of the castable, injectable and/or printable material are applied to the cell housing of the galvanic cell one after the other.

In one embodiment of the method for attaching spacer elements to a galvanic cell, it is provided that the castable, injectable and/or printable material comprises or is formed by polyurethane and/or silicone.

In one embodiment of the method for attaching spacer elements to a galvanic cell, it is provided that a bump and/or knobs are applied to, for example sprayed onto, the cell housing of the galvanic cell as spacer elements.

In one embodiment of the method for attaching spacer elements to a galvanic cell, it is provided that the castable, injectable and/or printable material is applied to the cell housing of the galvanic cell through a template.

The present invention also relates to a method for producing a battery module, which comprises the following:
providing two or more than two galvanic cells to which spacer elements are attached by means of the method according to the invention for attaching spacer elements to a galvanic cell;
stacking the galvanic cells along a stacking direction.

The galvanic cells are preferably stacked along the stacking direction in such a way that the cell housings of two adjacent galvanic cells are spaced apart from one another by means of the spacer elements applied thereto.

The method according to the invention for attaching spacer elements to a galvanic cell preferably has one or more of the features and/or advantages described in connection with the battery modules and/or galvanic cells according to the invention.

The galvanic cells and/or battery modules according to the invention preferably also have one or more of the features and/or advantages described in connection with the method according to the invention for attaching spacer elements to a galvanic cell.

Further features and/or advantages of the invention are the subject matter of the following description and the drawings illustrating embodiments.

### BRIEF DESCRIPTION OF THE DRAWINGS

FIG. 1 is a schematic perspective view of an embodiment of a battery module;

FIG. 2 is a schematic perspective exploded view of the embodiment of the battery module from FIG. 1;

FIG. 3 is a schematic perspective view of a spacer element of the embodiment of the battery module from FIG. 1;

FIG. 4 is a schematic sectional view of a galvanic cell and a spacer element of the embodiment of the battery module from FIG. 1;

FIG. 5 is a schematic sectional view of two adjacent galvanic cells and a spacer element arranged between the two adjacent galvanic cells of the embodiment of the battery module from FIG. 1;

FIG. 6 is a schematic perspective view of a spacer element of a further embodiment of a battery module;

FIG. 7 is a schematic perspective view of a spacer element of a further embodiment of a battery module;

FIG. 8 is a schematic perspective view of a spacer element of a further embodiment of a battery module;

FIG. 9 is a schematic perspective view of a spacer element of a further embodiment of a battery module;

FIG. 10 is a schematic perspective view of a spacer element of a further embodiment of a battery module;

FIG. 11 is a schematic perspective view of a spacer element of a further embodiment of a battery module;

FIG. 12 is a schematic sectional view of two adjacent galvanic cells and two spacer elements of a further embodiment of a battery module, which spacer elements are arranged between the two adjacent galvanic cells;

FIG. 13 is a schematic perspective view of a spacer element of a further embodiment of a battery module;

FIG. 14 is a schematic sectional view of a cross section along the line XIV-XIV in FIG. 13;

FIG. 15 is a sectional view corresponding to the sectional view from FIG. 14 of a spacer element of a further embodiment of a battery module;

FIG. 16 is a sectional view corresponding to the sectional view from FIG. 14 of a spacer element of a further embodiment of a battery module;

FIG. 17 is a schematic sectional view of a galvanic cell and a spacer element of a further embodiment of a battery module;

FIG. 18 is a schematic perspective view of a spacer element of a further embodiment of a battery module;

FIG. 19 is a schematic sectional view of a cross section along the line XIX-XIX in FIG. 18;

FIG. 20 is a schematic perspective view of a spacer element of a further embodiment of a battery module;

FIG. 21 is a schematic sectional view of a cross section along the line XXI-XXI in FIG. 20;

FIG. 22 is a schematic perspective view of a spacer element of a further embodiment of a battery module;

FIG. 23 is a schematic perspective exploded view of the spacer element from FIG. 22;

FIG. 24 is a schematic plan view of the spacer element of FIG. 22 when viewed in the direction of arrow 24 in FIG. 22;

FIG. 25 is a schematic sectional view of a cross section along the line XXV-XXV in

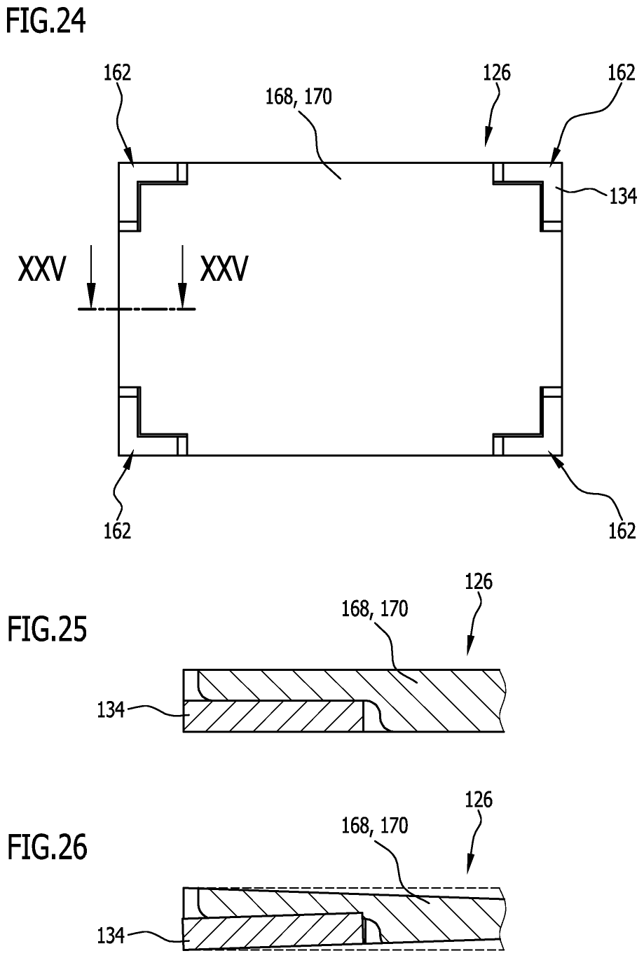

FIG. 24;

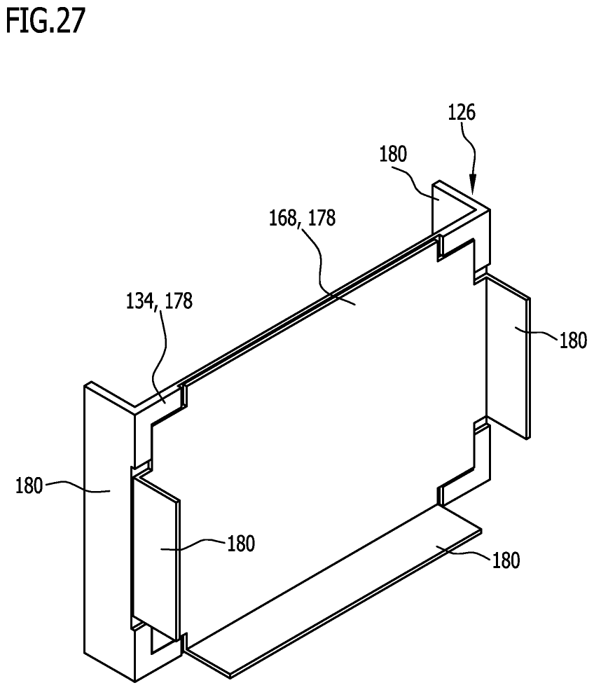

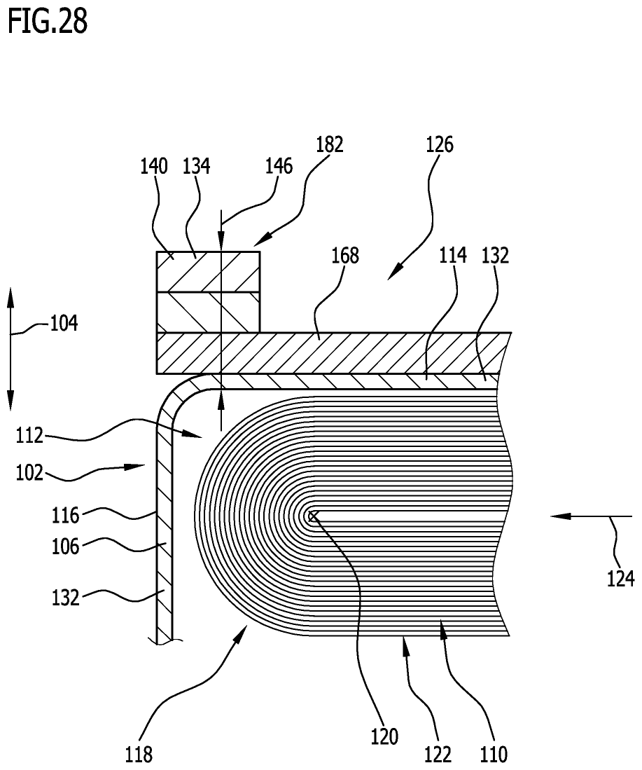

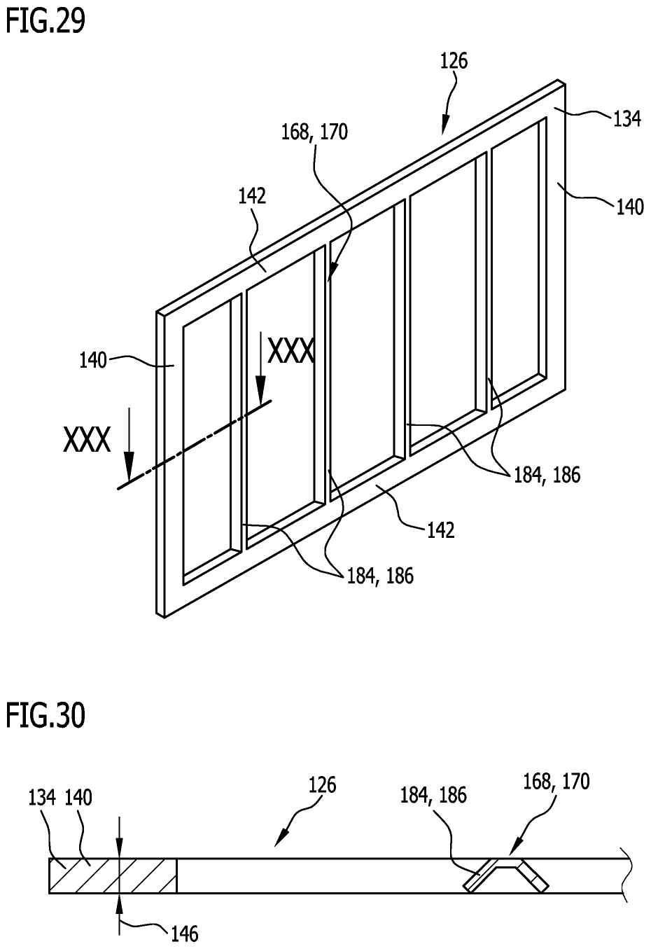

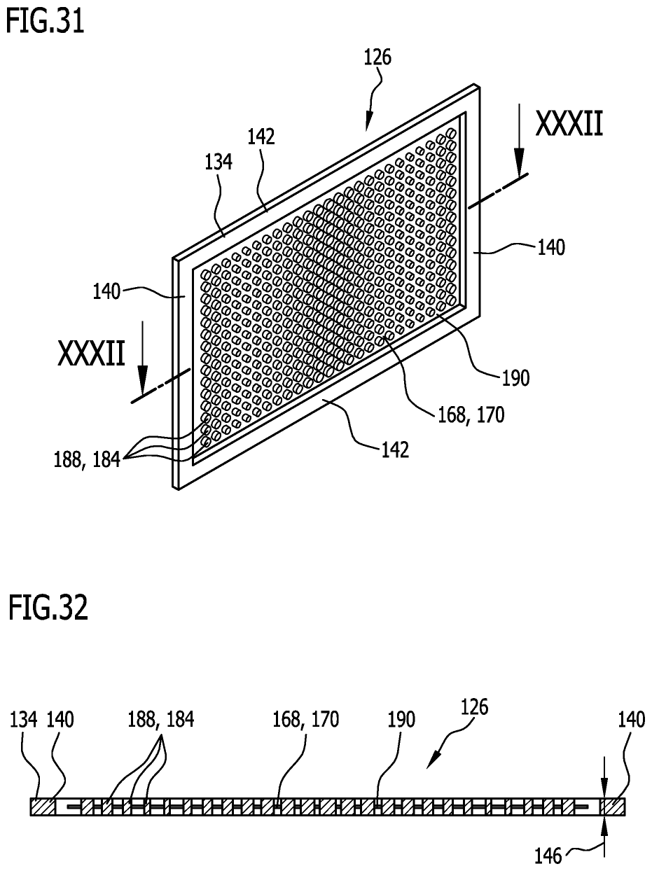

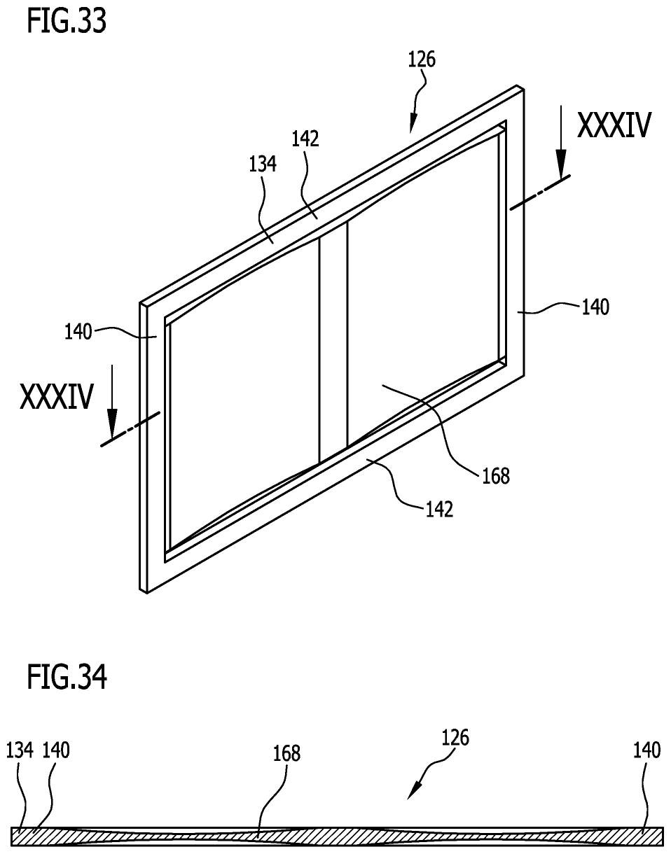

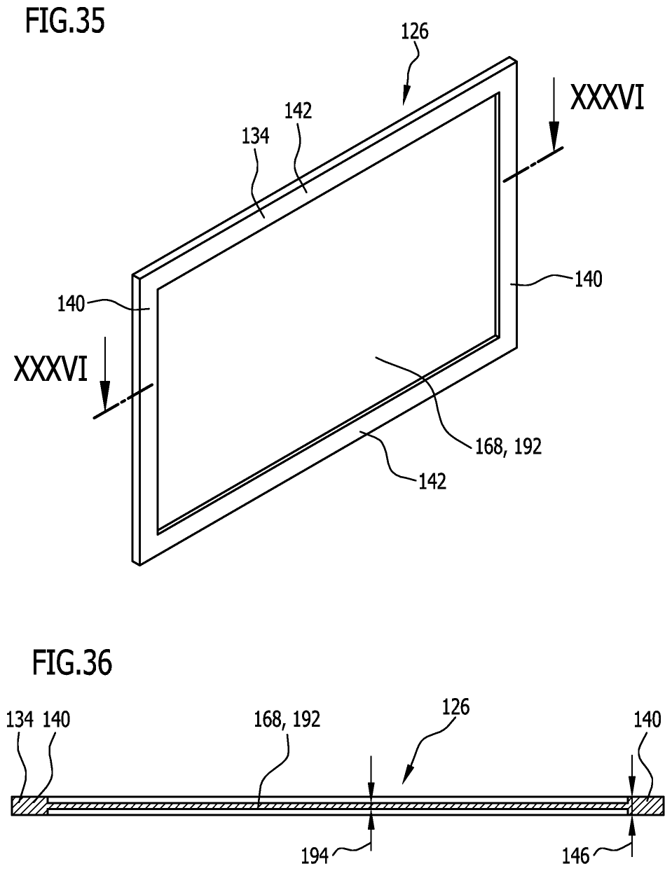

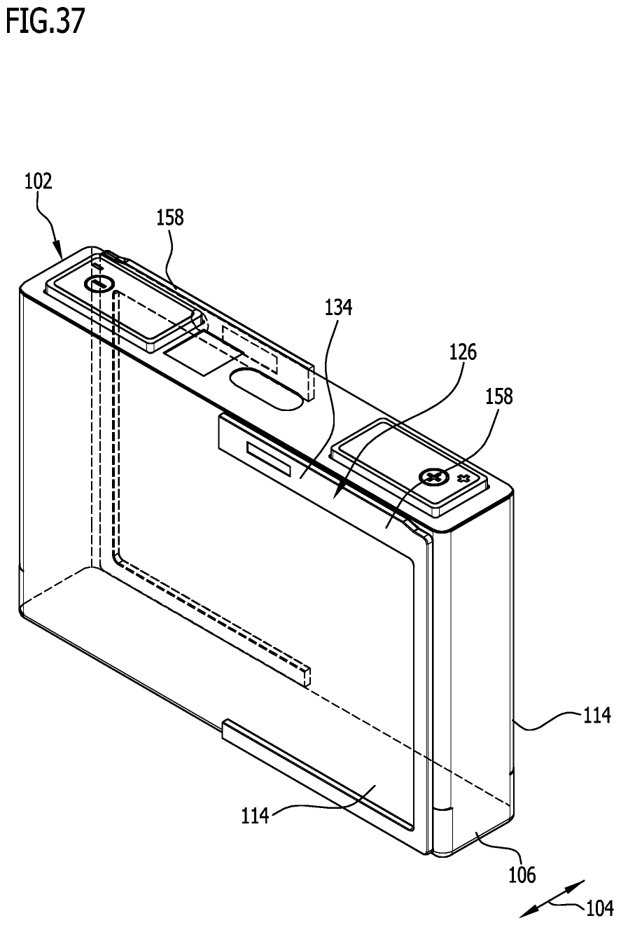

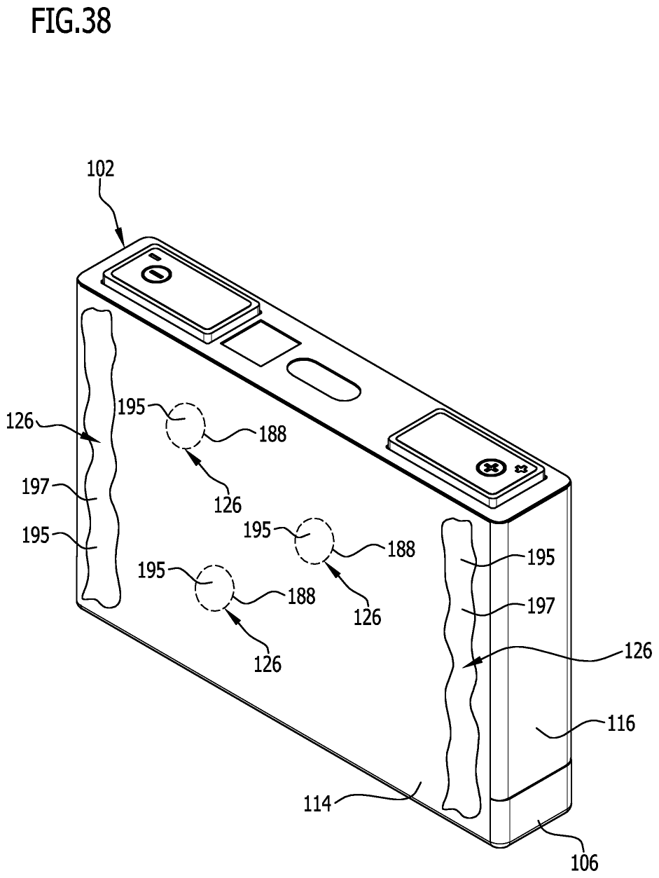

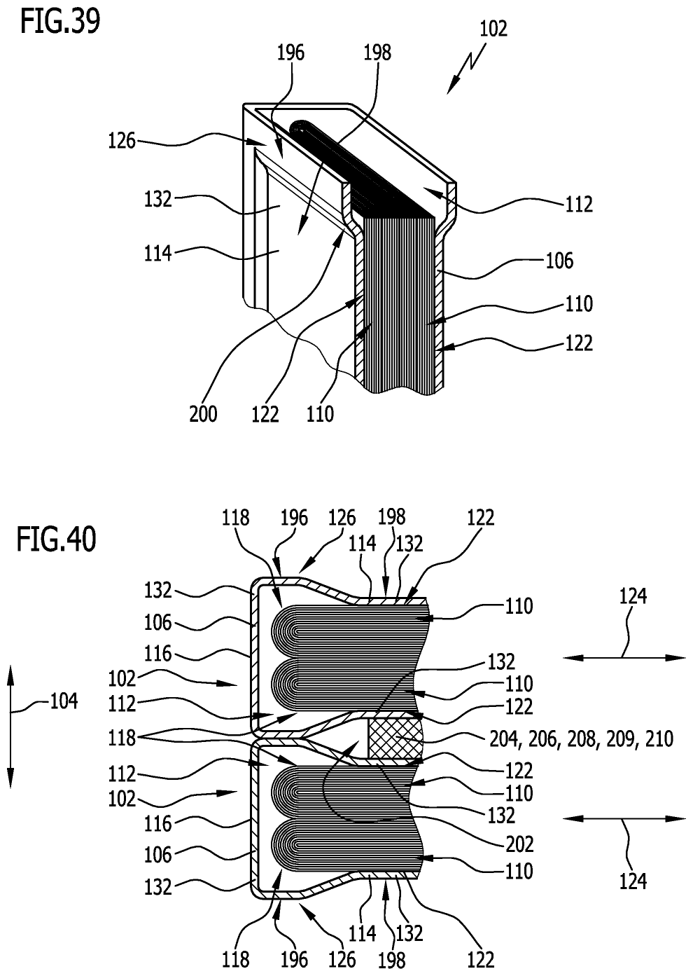

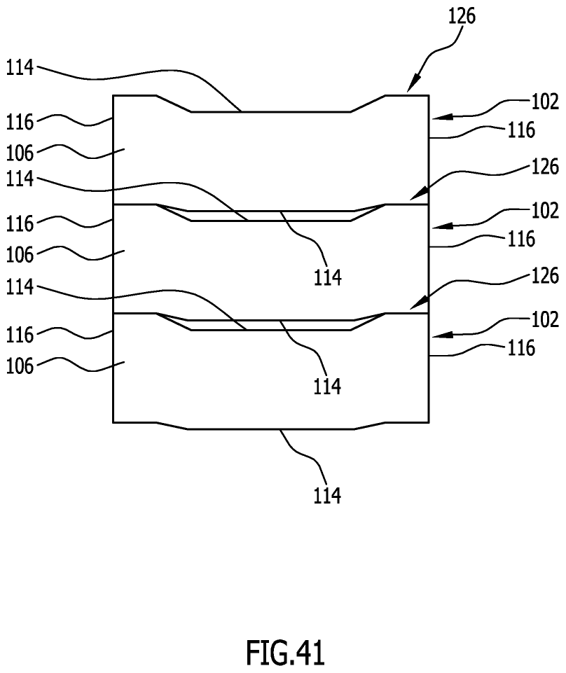

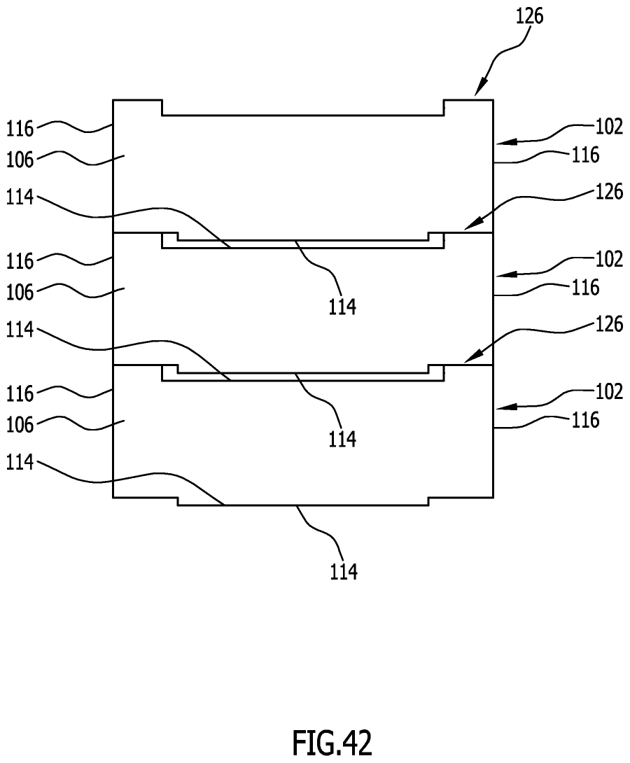

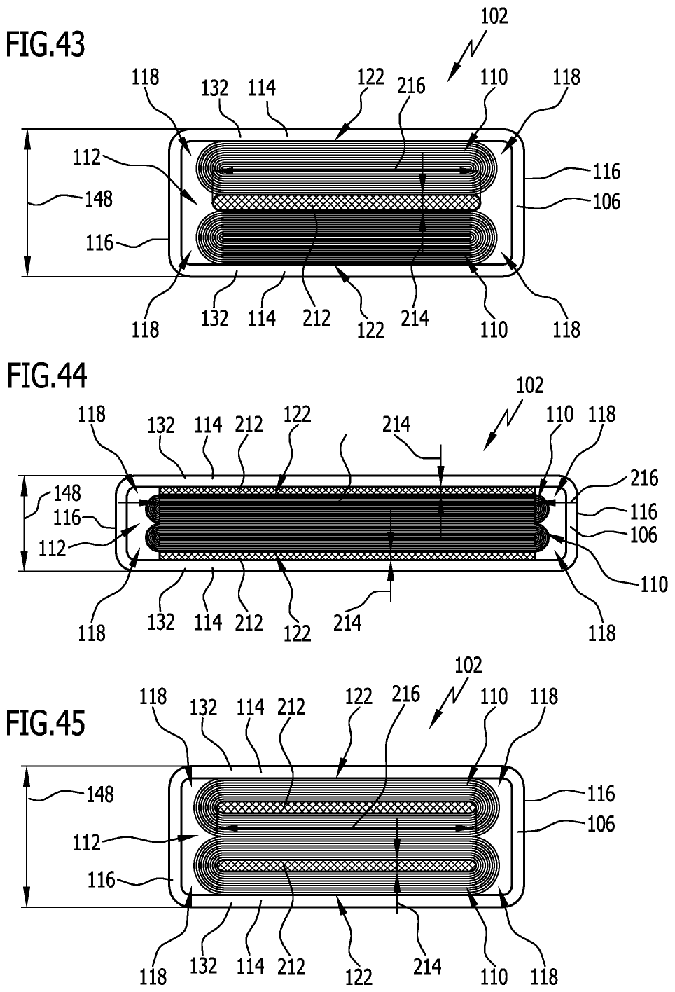

FIG. 26 is a sectional view corresponding to the sectional view of FIG. 25, a frame element and/or an intermediate element of the spacer element being deformed;

FIG. 27 is a schematic perspective view of a spacer element of a further embodiment of a battery module;

FIG. 28 is a schematic sectional view of a galvanic cell and a spacer element of a further embodiment of a battery module;

FIG. 29 is a schematic perspective view of a spacer element of a further embodiment of a battery module;

FIG. 30 is a schematic sectional view of a cross section along the line XXX-XXX in

FIG. 29;

FIG. 31 is a schematic perspective view of a spacer element of a further embodiment of a battery module;

FIG. 32 is a schematic sectional view of a cross section along the line XXXII-XXXII in

FIG. 31;

FIG. 33 is a schematic perspective view of a spacer element of a further embodiment of a battery module;

FIG. 34 is a schematic sectional view of a cross section along the line XXXIV-XXXIV in FIG. 33;

FIG. 35 is a schematic perspective view of a spacer element of a further embodiment of a battery module;

FIG. 36 is a schematic sectional view of a cross section along the line XXXVI-XXXVI in FIG. 35;

FIG. 37 is a schematic perspective view of a galvanic cell of a further embodiment of a battery module;

FIG. 38 is a schematic perspective view of a galvanic cell of a further embodiment of a battery module;

FIG. 39 is a schematic perspective partial sectional view of an embodiment of a galvanic cell;

FIG. 40 is a schematic sectional view of two galvanic cells according to the embodiment from FIG. 37;

FIG. 41 is a schematic sectional view of three galvanic cells according to a further embodiment;

FIG. 42 is a schematic sectional view of three galvanic cells according to a further embodiment;

FIG. 43 is a schematic sectional view of a further embodiment of a galvanic cell;

FIG. 44 is a schematic sectional view of a further embodiment of a galvanic cell; and

FIG. 45 is a schematic sectional view of a further embodiment of a galvanic cell.

The same or functionally equivalent elements are provided with the same reference signs in all figures.

### DETAILED DESCRIPTION OF THE DRAWINGS

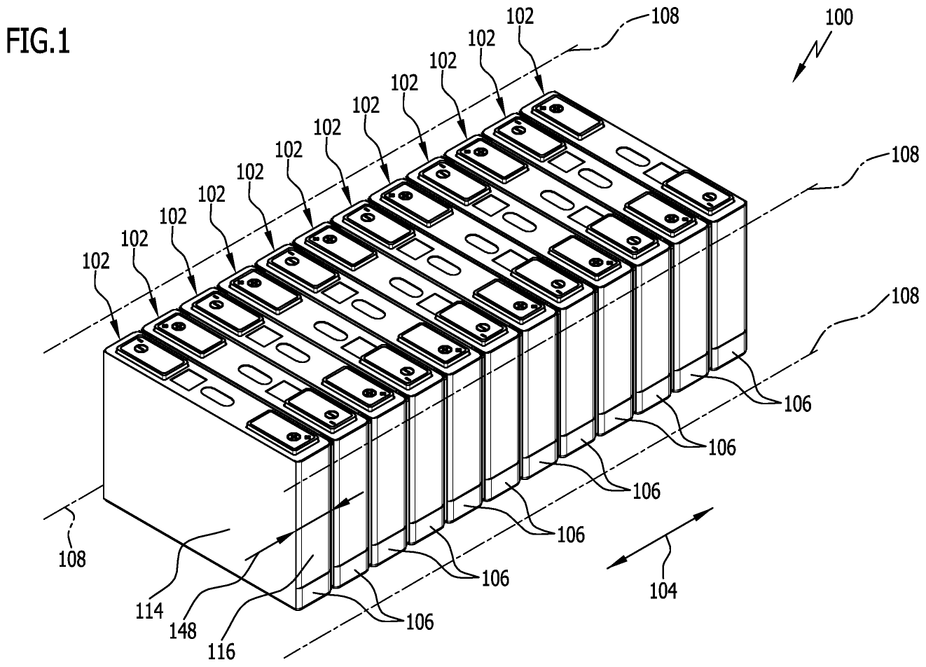

FIG. 1 shows a battery module designated as a whole as 100.

The battery module 100 preferably comprises two or more than two galvanic cells 102.

The galvanic cells 102 are preferably arranged along a stacking direction of the battery module 100, which is identified by an arrow 104 in FIG. 1.

The galvanic cells 102 of the battery module 100 arranged along the stacking direction 104 form in particular a cell stack.

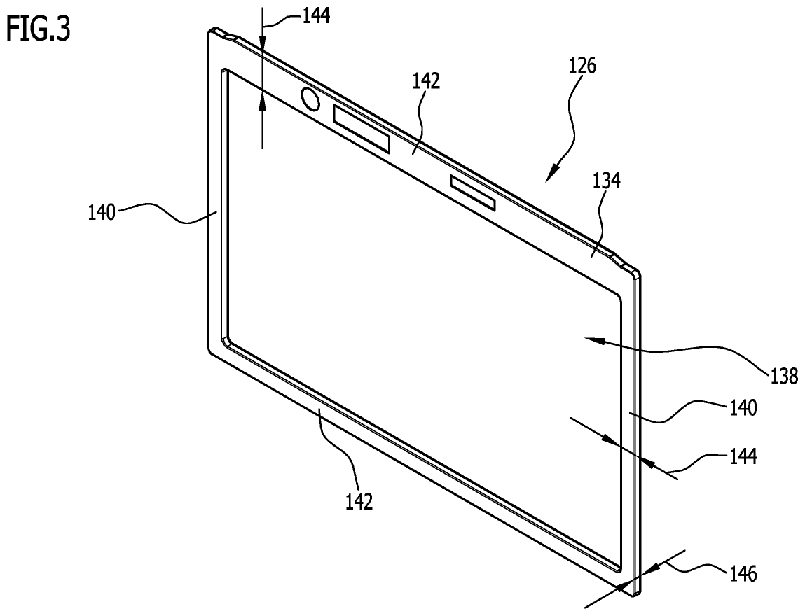

In the embodiments of a battery module illustrated in FIGS. 1 to 36, the galvanic cells 102 are preferably designed according to the PHEV2 format.

The galvanic cells 102 are preferably prismatic cells, in particular substantially cuboid cells.

The galvanic cells 102 preferably each comprise a cell housing 106.

It can be favorable if the galvanic cells 102 of the battery module 100 are braced along the stacking direction 104.

For example, it can be provided that all galvanic cells 102 of the battery module 100 are arranged in the stacking direction 104 between two end plates, not shown in the drawing, the two end plates being braced along the stacking direction 104 by means of a plurality of clamping elements 108, which are shown in FIG. 1 only schematically by means of dash-dot lines. The clamping elements 108 are, for example, what are known as “tie rods.”

The battery module 100 preferably comprises a battery module housing, not shown in the drawings, in which the galvanic cells 102 of the battery module 100 are arranged.

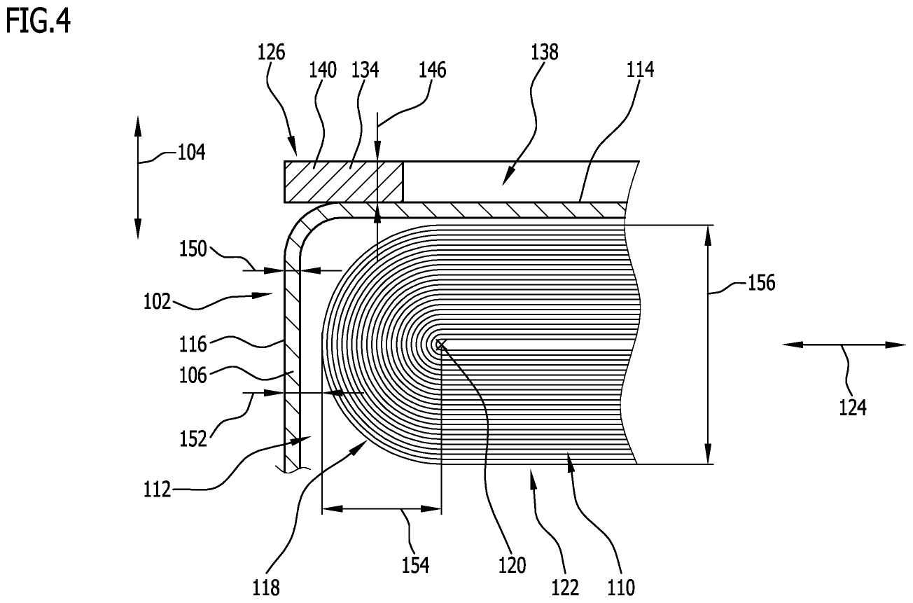

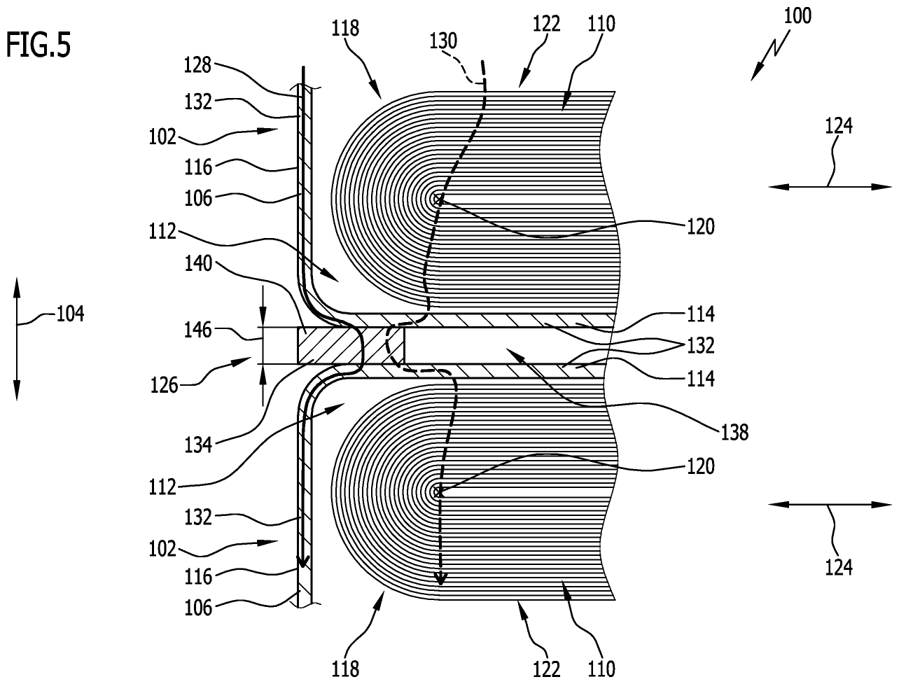

A respective galvanic cell 102 preferably comprises two cell windings 110 (“jelly rolls”), which are shown in FIGS. 4 and 5, for example.

The cell housing 106 of a respective galvanic cell 102 preferably comprises or forms a receiving space 112.

It can be favorable if the two cell windings 110 of a respective galvanic cell 102 are received in the receiving space 112.

The galvanic cells 102 of the battery module are preferably secondary cells. The galvanic cells 102 are thus preferably rechargeable galvanic cells 102.

The battery module 100 thus forms in particular an accumulator module.

A respective galvanic cell 102 and/or a cell housing 106 of a respective galvanic cell 102 preferably comprises two primary sides 114 and four secondary sides 116. Preferably, the two primary sides 114 and/or two secondary sides 116 are arranged on opposing sides of a respective galvanic cell 102 and/or of a cell housing 106 of a respective galvanic cell 102.

In particular, a primary side 114 of a galvanic cell 102 and/or of a cell housing 106 of the galvanic cell 102 faces a primary side 114 of a further galvanic cell 102 and/or a cell housing 106 of the further galvanic cell 102.

It can be favorable if the two cell windings 110 of the galvanic cells 102 are arranged substantially parallel to one another.

The cell windings 110 of a galvanic cell 102 of the battery module 100 are preferably flat windings.

A respective cell winding 110 of the galvanic cells 102 of the battery module 100 comprises, in particular, a plurality of winding layers.

Winding layers of a respective cell winding 110 are preferably arranged substantially parallel to one another.

The cell winding 110 preferably comprises a winding layer web that forms the winding layers. The winding layers are preferably formed by winding up the winding layer web. In particular, it is conceivable that a single winding layer web comprises or forms all winding layers of a respective cell winding 110.

A respective cell winding 110 of a galvanic cell 102 preferably comprises two deflection regions 118 in which winding layers of the respective cell winding 110 are deflected, the winding layers having a common winding line 120 in a respective deflection region 118.

In the respective deflection region 118 of the cell winding 110, winding layers of the cell windings 102 are preferably deflected, in particular by approximately 180°.

The winding lines 120 of the two deflection regions 118 of a respective cell winding 110 are preferably arranged substantially parallel to one another.

In particular, a respective cell winding 110 of the galvanic cells 102 is formed axially symmetrically with respect to the common winding line 120 in a deflection region 118.

In particular, it is conceivable that the winding layers of the respective cell winding 110 are arranged substantially in a semicircle in a respective deflection region 118 in a cross section taken perpendicularly to the common winding line 120.

Winding layers of a respective cell winding 110 are arranged in an intermediate region 122 of the cell winding 110 arranged between the two deflection regions 118 of the cell winding 110, preferably substantially parallel to a central plane of the cell winding 110 that is not illustrated in the drawings.

It can be favorable if the common winding line 120 of a respective deflection region of a cell winding is arranged in the central plane of a cell winding 110.

The stacking direction 104 of the battery module 100 preferably runs substantially perpendicular to a central plane of the cell windings 110 of the galvanic cells 102 of the battery module 100.

It can be favorable if the common winding line 120 of winding layers of the respective cell winding 110 forms a common central point of semicircularly arranged winding layers of the cell winding 110 in a respective deflection region 118 of the cell winding 110 in a cross section taken perpendicularly to the common winding line 120.

A winding direction of a respective cell winding 110, represented by means of an arrow 124, preferably runs perpendicular to the common winding lines 120 of the two deflection regions 118 of the respective cell winding 110 and in particular perpendicular to the stacking direction 104.

A winding layer of a respective cell winding 110 preferably comprises a plurality of layers, for example two electrode layers and two separator layers.

In particular, it can be favorable if electrode layers and separator layers are arranged alternately in a winding layer.

A layer sequence in a winding layer of a cell winding 110 is therefore preferably as follows: separator layer, electrode layer, separator layer, electrode layer.

The electrode layers preferably comprise or are formed from an electrically conductive material, for example aluminum or copper.

The separator layers preferably comprise or are formed from an electrically insulating material, for example polyethylene and/or polypropylene.

The embodiment of a battery module 100 shown in FIGS. 1 to 5 preferably also comprises a plurality of spacer elements 126.

In the embodiment of a battery module 100 shown in FIGS. 1 to 5, a spacer element 126 is preferably arranged between two adjacent galvanic cells 102, in particular between the cell housings 106 of the two adjacent galvanic cells.

Mutually facing cell windings 110 of two adjacent galvanic cells 102 are preferably arranged at a distance from one another in the stacking direction 126, in each case by means of a spacer element 126.

A predetermined distance between two adjacent galvanic cells 102 can preferably be adjusted by means of the spacer elements 126.

An expansion of the galvanic cells 102, in particular of the cell housings 106 of the galvanic cells 106, which is due to gas formation due to chemical decomposition of the electrolyte, is preferably substantially prevented by means of the spacer elements 126.

An expansion of the galvanic cells 102, in particular of the cell housings 106 of the galvanic cells 102, which is due to growth of the cell windings 110 of the galvanic cells 102, is preferably also permitted by means of the spacer elements 126.

It is preferably conceivable that delamination of the cell windings 110 of the galvanic cells 102 can be prevented due to the limitation of an expansion of the galvanic cells 102, which expansion is due to gas formation. In particular, aging of the galvanic cells 102 is delayed.

A pressure on the cell windings 110 of the galvanic cells 102 of the battery module 100 can preferably be reduced by means of the spacer elements 126. In particular, a drop in capacity of the galvanic cells 102 of the battery module 100 can be reduced. It can also be favorable if mechanical overstressing of the cell windings 110 of the galvanic cells 102 is avoided by means of the spacer elements 126.

The spacer elements 126 are preferably arranged and/or designed in such a way that the introduction of force into the cell windings 110 of the galvanic cells 102 in the stacking direction 104 of the battery module 100 can be avoided, in particular in the region of a common winding line 120 of the deflection regions 118 of the cell windings 110.

A force flux in the stacking direction 104 of the battery module 100 can preferably be guided by means of the spacer elements 126 in such a way that preferably no force is exerted on a common winding line 120 of the deflection regions 118 of the cell windings 110 in the stacking direction.

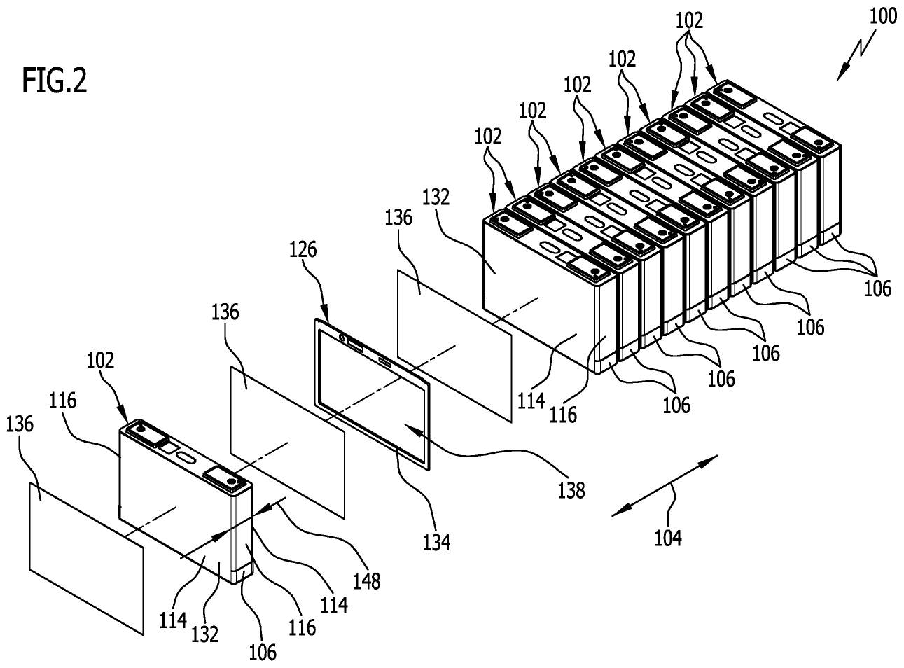

FIGS. 2 and 5 show in each case that a spacer element 126 is arranged between mutually facing cell housing walls 132 of the cell housings 106 of two adjacent galvanic cells 102.

The spacer elements 126 are in particular each arranged on a primary side 114 of the cell housings 106.

In the embodiment of a battery module 100 shown in FIGS. 1 to 5, the spacer elements 126 preferably each comprise or form only one frame element 134.

A predetermined distance can preferably be fixed between two adjacent galvanic cells 102 by means of frame elements 134, in particular on an edge region of the mutually facing primary sides 114 of the respective cell housings 106 of the galvanic cells 102.

The frame elements 134 are preferably each formed in one part.

In particular, all frame elements 134 of the battery module 100 arranged between two cell housings 106 of two adjacent galvanic cells 102 are of identical design.

FIG. 5 shows a force flux through the frame elements 134 that is identified by means of a solid line 128.

A force thus preferably does not flow substantially along the dashed line 130 in FIG. 5.

It can be favorable if a force flows between adjacent galvanic cells 102 in the stacking direction 104 of the battery module 100 substantially via the frame elements 134.

A force flows between adjacent galvanic cells 102 in the stacking direction 104 of the battery module 100 preferably exclusively or to an extent of at least approximately 75%, in particular to an extent of at least approximately 85%, preferably to an extent of at least approximately 95%, via the frame elements 134.

The frame elements 134 preferably comprise or are formed from a fiber-reinforced plastic material, such as glass-fiber-reinforced polybutylene terephthalate (PBT) or glass-fiber-reinforced polypropylene (PP).

Preferably, a frame element 134 arranged between cell housings 106 of two adjacent galvanic cells 102 is integrally connected, in particular bonded, to the cell housings 106 of the two adjacent galvanic cells 102.

It is particularly conceivable here that the frame element 134 is integrally connected, in particular bonded, to an electrical insulation film not shown in the drawing that is applied directly to a cell housing wall 132 of the cell housing 106 and/or connected thereto.

A respective frame element 134 is preferably bonded to the cell housings 106 of two adjacent galvanic cells 102 by means of an adhesive film 136, which is in each case arranged between a primary side 114 of a cell housing 106 of a respective galvanic cell 102 and the frame element 134.

The frame elements 134 preferably each delimit an interior space 138 surrounded by a frame element 134 and two adjacent cell housings 106.

In the embodiment of the battery module 100 shown in FIGS. 1 to 5, preferably only gas, for example air, is arranged in the interior space 138.

The frame element 134 preferably comprises two supporting webs 140 and two connecting webs 142.

The two supporting webs 140 are preferably arranged parallel to one another and/or parallel to a common winding line 120 of a deflection region 118 of a cell winding 110 of a galvanic cell 102.

It can be favorable if the two supporting webs 140 are connected by means of the two connecting webs 142.

The frame elements 134 are preferably closed in a ring shape.

The two supporting webs 140 are preferably arranged substantially parallel to one another.

It can also be favorable if the connecting webs 142 are arranged substantially parallel to one another.

The supporting webs 140 and/or the connecting webs 142 of a respective frame element 134 preferably run along an edge region of a respective primary side 114 of two adjacent cell housings 106.

It can be favorable if the supporting webs 140 and/or the connecting webs 142 of the frame elements 134 do not have a sharp edge on a side of the frame element 134 that rests against a respective cell housing 106.

In particular, it can be provided that the edges of the supporting webs 140 and/or the connecting webs 142 of the frame element 134 are rounded on a side of the frame element 134 that rests against a respective cell housing 106.

Stress peaks and/or edge imprints on the cell housing 106 can preferably be avoided.

The two supporting webs 140 and/or the two connecting webs 142 preferably have a substantially constant width 144 perpendicular to a main direction of extent thereof.

For example, it is conceivable that the width 144 of the two supporting webs 140 substantially corresponds to the width 144 of the two connecting webs 142.

The width 144 of the two supporting webs 140 of a frame element 134 preferably corresponds approximately to a sum of a wall thickness 150 of the cell housing wall 132 of a cell housing 106 of a galvanic cell 102, a distance 152 of a cell winding 110 from the cell housing wall 132 of the cell housing 106 and a width 154 of a deflection region 118 of a cell winding 102.

The width 154 of a deflection region 118 of a cell winding 110 preferably corresponds substantially to half a thickness 156 of a cell winding 110 parallel to a stacking direction of the battery module.

The aforementioned dimensions preferably relate to a direction parallel to the winding direction 124 of a cell winding 102 and/or perpendicular to the stacking direction 104 of the battery module 100, measured in particular in a central plane of a respective cell winding 102.

The main direction of extent of the two supporting webs 140 and/or the two connecting webs 142 runs, in particular, perpendicular to the stacking direction 104 of the battery module 102.

The main direction of extent of the two supporting webs 140 preferably runs parallel to a common winding line 120 of a deflection region 118 of a cell winding 110 of the galvanic cells 102.

It can be favorable if the supporting webs 140 of the frame element 134 and/or the connecting webs 142 of the frame element 134 have a constant thickness 146 in a direction parallel to the stacking direction 104 of the battery module 100.

A maximum thickness 146 of frame element 134, in particular of supporting webs 140 and/or connecting webs 142, preferably corresponds to at least approximately 5%, in particular at least approximately 7.5%, for example at least approximately 10%, of a height 148 of a cell housing 106 of galvanic cells 102 in the stacking direction 104.

It can be favorable if a projection of a respective supporting web 140 of a frame element 134, in particular a region of the supporting web 140 abutting the cell housing 106 of a galvanic cell 102, along the stacking direction 104 onto a projection plane arranged perpendicular to the stacking direction 104 is at a distance from a projection of a respective common winding line 120 of a deflection region 118 of a cell winding 110 of a galvanic cell 102.

Preferably, the projection of the supporting web 140, in particular of the region of the supporting web 140 abutting the cell housing 106, is at a distance parallel to a winding direction 124, in particular outward, from the projection of the common winding line 120.

The projection of the region of the supporting web 140 that abuts the cell housing 106 preferably does not overlap the projection of the common winding line 120.

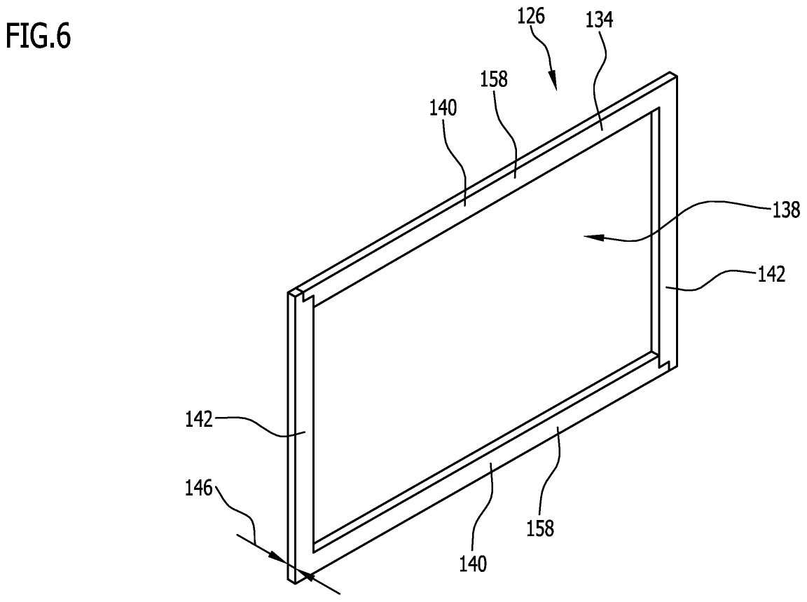

A spacer element 126 shown in FIG. 6, in particular a frame element 134, of an embodiment of a battery module 100 differs from the spacer element 126 of an embodiment of a battery module 100 shown in FIGS. 1 to 5 substantially in that the frame element 134 is designed in multiple parts, in particular in two parts.

The frame element 134 comprises, in particular, two frame element parts 158.

The two frame element parts 158 can preferably be connected to one another in a force-fitting and/or form-fitting manner, for example by means of a plug-in connection, which is not shown in the drawing.

The two frame element parts are L-shaped, for example, and can be connected to one another to produce a frame element 134 that is closed in a ring shape.

Otherwise, the spacer element 126 shown in FIG. 6, in particular the frame element 134, of the embodiment of a battery module 100 corresponds in terms of structure and function to the spacer element 126 shown in FIGS. 1 to 5 of an embodiment of a battery module 100, such that reference is made to the above description thereof.

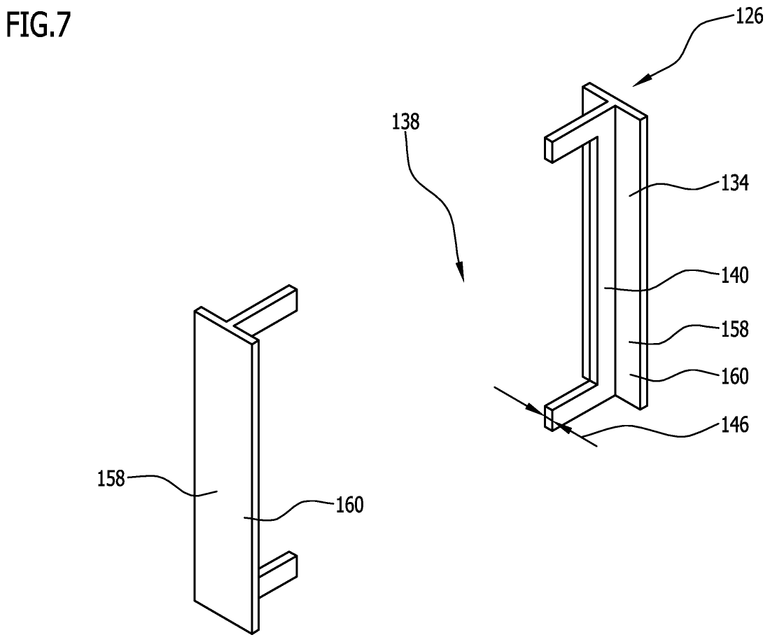

A spacer element 126 shown in FIG. 7, in particular a frame element 134, of an embodiment of a battery module 100 differs from the spacer element 126 shown in FIG. 6 of an embodiment of a battery module 100 substantially in that the frame element 134 substantially comprises only two supporting webs 140.

In each case, a supporting web 140 preferably forms a frame element part 158.

The two frame element parts 158 are preferably substantially T-shaped in a cross section taken perpendicularly to a common winding line 120 of a deflection region 118 of a cell winding 110 of a galvanic cell 102.

In each case, the two frame element parts 158 comprise stop elements 160 arranged perpendicular to the supporting webs.

It can be favorable if the stop elements 160 can be placed against a secondary side 116 of a cell housing 106 of a respective galvanic cell 102 in order to position the frame element parts 158.

Otherwise, the spacer element 126 shown in FIG. 7, in particular the frame element 134, of the embodiment of a battery module 100 corresponds in terms of structure and function to the spacer element 126 shown in FIG. 6 of an embodiment of a battery module 100, such that reference is made to the above description thereof.

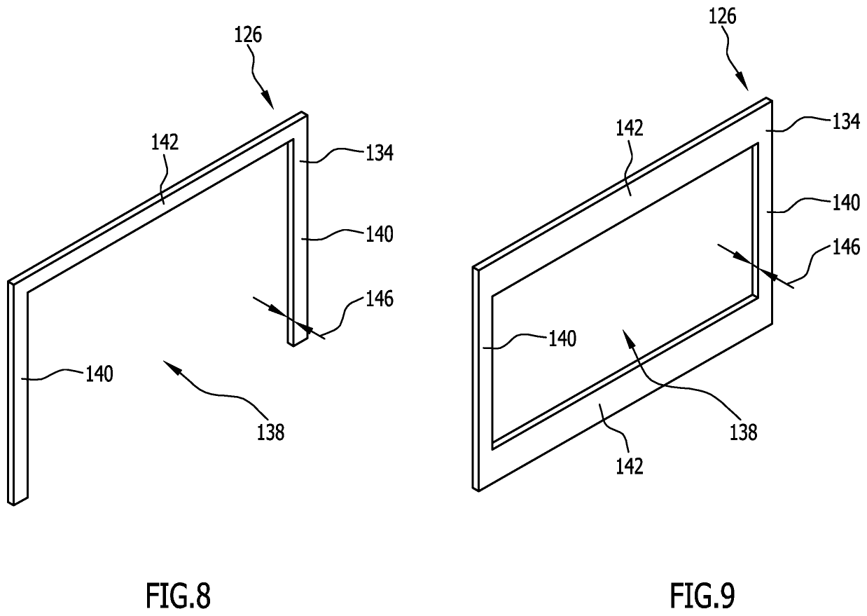

A spacer element 126 shown in FIG. 8, in particular a frame element 134, of an embodiment of a battery module 100 differs from the spacer element 126 of an embodiment of a battery module 100 shown in FIGS. 1 to 5 substantially in that the frame element 134 comprises only a single connecting web 142.

The frame element 134 is, in particular, not a frame element 134 closed in a ring shape.

The frame element 134 is preferably substantially U-shaped and preferably surrounds the interior space 138 on at least three sides.

Otherwise, the spacer element 126 shown in FIG. 8, in particular the frame element 134, of the embodiment of a battery module 100 corresponds in terms of structure and function to the spacer element 126 shown in FIGS. 1 to 5 of an embodiment of a battery module 100, such that reference is made to the above description thereof.

A spacer element 126 shown in FIG. 9, in particular a frame element 134, of an embodiment of a battery module 100 differs from the spacer element 126 of an embodiment of a battery module 100 shown in FIGS. 1 to 5 substantially in that the width 144 of the two supporting webs 140 is different from the width 144 of the two connecting webs 142.

The width 144 of the two connecting webs 142 is greater, for example, by a factor of at least approximately 1.5, than the width 144 of the two supporting webs 140, for example by a factor of at least approximately 2.

Otherwise, the spacer element 126 shown in FIG. 9, in particular the frame element 134, of the embodiment of a battery module 100 corresponds in terms of structure and function to the spacer element 126 shown in FIGS. 1 to 5 of an embodiment of a battery module 100, such that reference is made to the above description thereof.

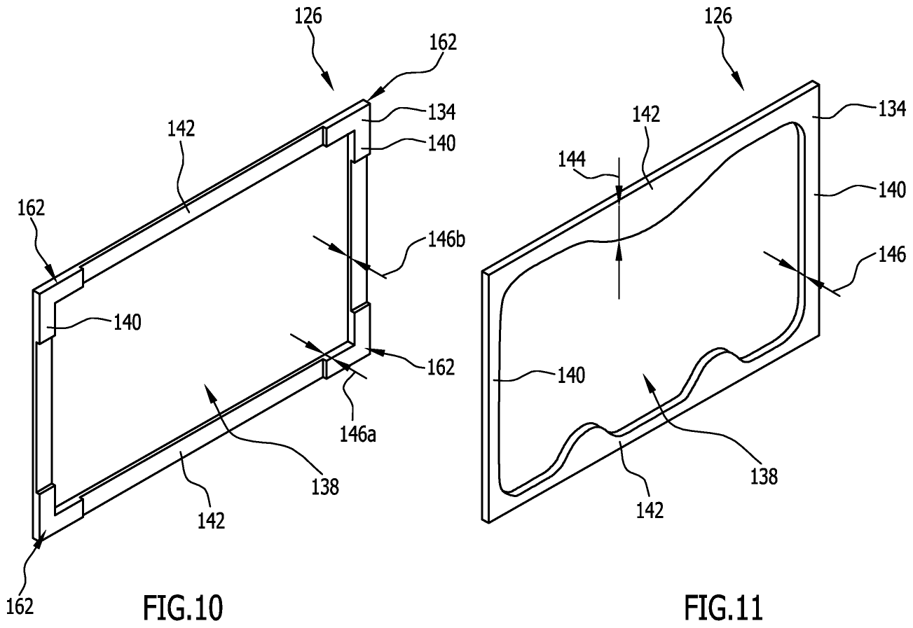

A spacer element 126 shown in FIG. 10, in particular a frame element 134, of an embodiment of a battery module 100 differs from the spacer element 126 of an embodiment of a battery module 100 shown in FIGS. 1 to 5 substantially in that the supporting webs 140 and/or the connecting webs 142 of the frame element 134 have a locally varying thickness 146 in a direction parallel to the stacking direction 104 of the battery module 100.

The supporting webs 140 and/or the connecting webs 142 of the frame element 134 preferably have a first thickness 146a in corner regions 162 in which the supporting webs 140 and the connecting webs 142 are connected to one another.

The supporting webs 140 and/or the connecting webs 142 of the frame element 134 preferably have a second thickness 146b between two corner regions 162 in each case.

Preferably, the first thickness 146a is greater than the second thickness 146b, for example by a factor of 2.

Because the supporting webs 140 and/or the connecting webs 142 of the frame element 134 have a greater thickness 146a in the corner regions 162 than outside of the corner regions 162, a force can preferably flow between adjacent galvanic cells 102 in the stacking direction 104 substantially via particularly rigid regions of the cell housings 106 of the galvanic cells 102.

Otherwise, the spacer element 126 shown in FIG. 10, in particular the frame element 134, of the embodiment of a battery module 100 corresponds in terms of structure and function to the spacer element 126 shown in FIGS. 1 to 5 of an embodiment of a battery module 100, such that reference is made to the above description thereof.

A spacer element 126 shown in FIG. 11, in particular a frame element 134, of an embodiment of a battery module 100 differs from the spacer element 126 of an embodiment of a battery module 100 shown in FIGS. 1 to 5 substantially in that the two supporting webs 140 and/or the two connecting webs 142 have a varying width 144 perpendicular to a main direction of extent thereof.

In this case, an inner profile of the frame element 134 can preferably be adapted to a swelling behavior of two adjacent galvanic cells 102.

Otherwise, the spacer element 126 shown in FIG. 11, in particular the frame element 134, of the embodiment of a battery module 100 corresponds in terms of structure and function to the spacer element 126 shown in FIGS. 1 to 5 of an embodiment of a battery module 100, such that reference is made to the above description thereof.

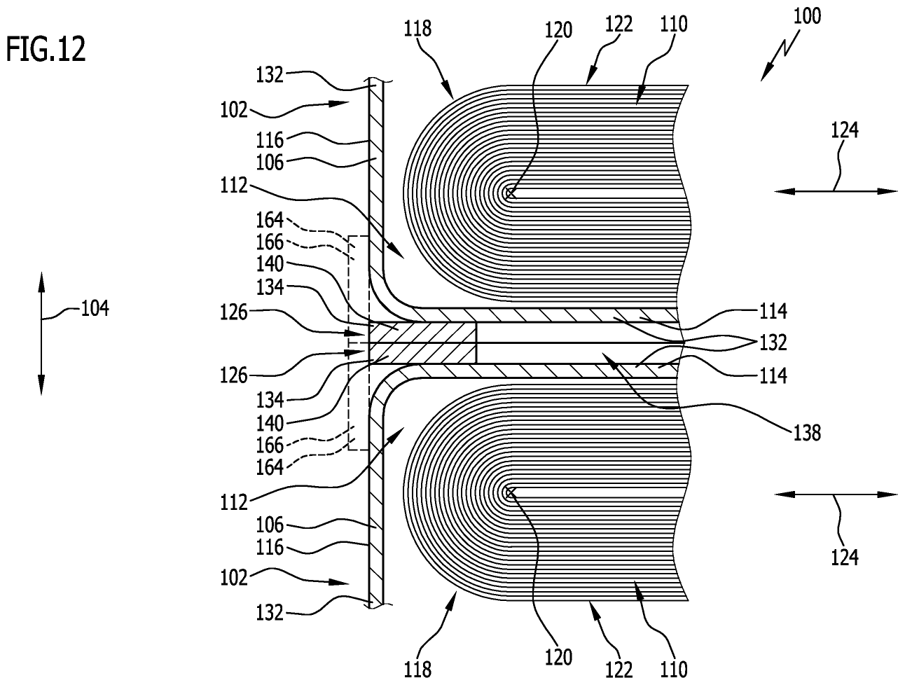

An embodiment of a battery module 100 shown in FIG. 12 differs from the embodiment of a battery module 100 shown in FIGS. 1 to 5 substantially in that a plurality of spacer elements 126, in particular a plurality of frame elements 134, are arranged one behind the other in the stacking direction 104 of the battery module 100.

In particular, two spacer elements 126, in particular two frame elements 134, are arranged between cell housings 106 of two adjacent galvanic cells 102.

In particular, it can be favorable if a spacer element 126, in particular a frame element 134, is arranged on opposing primary sides 114 of a cell housing 106 of a respective galvanic cell 102 on the cell housings 106 of the two adjacent galvanic cells 102.

Parallel to the stacking direction 104 of the battery module 100, a sequence is preferably as follows: spacer element 126, galvanic cell 102, spacer element 126, spacer element 126, galvanic cell 102, spacer element 126, spacer element 126, galvanic cell 102, spacer element 126, spacer element 126, galvanic cell 102, etc.

Preferably, two frame elements 134 are in each case slipped onto a galvanic cell 102, in particular onto the cell housing 106 of the galvanic cell 102.

The two frame elements 134 enclose the respective galvanic cell 102, in particular the cell housing 106 of the galvanic cell 102, at least approximately in a C-shape.

The two frame elements 134 preferably each comprise an at least approximately C-shaped receiving portion, in which a cell housing 106 of a galvanic cell 102 is at least in part received parallel to the stacking direction 104 of the battery module 102.

The two frame elements 134 preferably also each comprise two supporting webs 140 and two connecting webs 142 and are preferably also closed in a ring shape.

It can be favorable if the two frame elements 134 each comprise two or more than two, for example four, fastening projections 164 that protrude away from the two supporting webs 140 and/or the two connecting webs 142 parallel to the stacking direction 104 of the battery module 102.

In each case, a fastening projection 164, in particular a fastening web 166, preferably protrudes away from a supporting web 140 and/or from a connecting web 142 parallel to the stacking direction 104 of the battery module 102.

The length of fastening webs 166 preferably substantially corresponds to the length of supporting webs 140 and/or connecting webs 142, in particular parallel to a main direction of extent of supporting webs 140 and/or connecting webs 142.

The fastening projections 164 and/or fastening webs 166 preferably surround a cell housing 106 of a galvanic cell 102 on four sides.

Preferably, the two frame elements 134 can easily be plugged onto opposing primary sides 114 of a cell housing 106 of a galvanic cell 102. In particular, the cell housing 106 having the frame elements 134 arranged thereon can then easily be positioned in a battery module housing.

Otherwise, the embodiment of a battery module 100 shown in FIG. 12 corresponds in terms of structure and function to the embodiment of a battery module 100 shown in FIGS. 1 to 5, such that reference is made to the above description thereof.

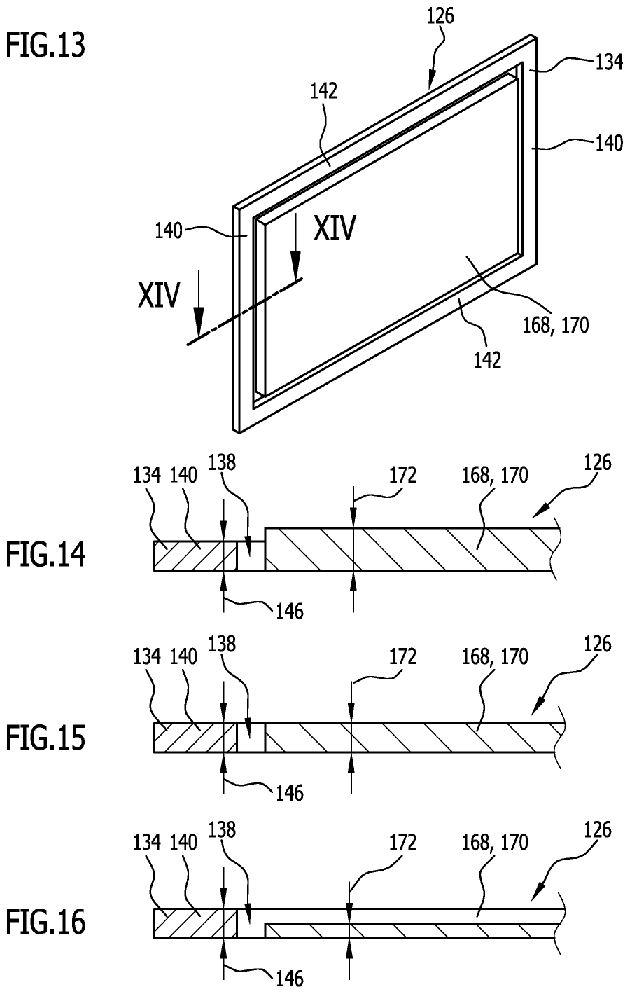

A spacer element 126 of an embodiment of a battery module 100 shown in FIGS. 13 and 14 differs from the spacer element 126 of an embodiment of a battery module 100 shown in FIGS. 1 to 5 substantially in that the spacer element 126 comprises or forms an intermediate element 168.

In the spacer element 126 shown in FIGS. 13 and 14, the frame element 134 is preferably not connected to the intermediate element 168.

The intermediate element 168 is preferably arranged in the interior space 138, in particular completely.

For example, it is conceivable that the intermediate element 168 fills the interior space 138 in a direction perpendicular to the stacking direction 104 of the battery module 100 to an extent of at least approximately 50%, for example to an extent of at least approximately 75%, preferably to an extent of at least approximately 95%, in particular completely.

Preferably, the frame element 134 and the intermediate element 168 comprise or are formed from different materials.

For example, it is conceivable that the intermediate element 168 forms a deformable compensation element 170.

For example, it is also conceivable that an intermediate element 168 designed as a deformable compensation element 170 comprises or is formed from a rubber material.

It can be favorable if the compensation element 170 can be compressed parallel to the stacking direction 104 of the battery module 100.

An intermediate element 168 designed as a compressible compensation element 170 comprises in particular a compressible material, for example a foam material, or is formed therefrom.

The compressible material of an intermediate element 168 designed as a compressible compensation element 170 is, for example, elastically or plastically compressible.

Preferably, the intermediate element 168 designed as a compressible compensation element 170 is prestressed between two adjacent cell housings 106 parallel to the stacking direction 104 of the battery module 100 in the delivered state of the battery module 100.

In an uninstalled and/or unloaded state, the compressible compensation element 170 has a maximum thickness 172, which is greater than the thickness 146 of the frame element 134, in particular of the supporting webs 140 of the frame element 134.

Otherwise, the spacer element 126 shown in FIG. 13 of the embodiment of a battery module 100 corresponds in terms of structure and function to the spacer element 126 shown in FIGS. 1 to 5 of an embodiment of a battery module 100, such that reference is made to the above description thereof.

A spacer element 126 of an embodiment of a battery module 100 shown in FIG. 15 differs from the spacer element 126 of an embodiment of a battery module 100 shown in FIGS. 13 and 14 substantially in that the intermediate element 168 designed as a compressible compensation element 170 has a maximum thickness 172 parallel to the stacking direction 104 of the battery module 100 when it is new, which thickness corresponds to a maximum thickness 146 of the frame element 134, in particular of the supporting webs 140 of the frame element 134.

Otherwise, the spacer element 126 shown in FIG. 15 of the embodiment of a battery module 100 corresponds in terms of structure and function to the spacer element 126 shown in FIGS. 13 to 14 of an embodiment of a battery module 100, such that reference is made to the above description thereof.

A spacer element 126 of an embodiment of a battery module 100 shown in FIG. 16 differs from the spacer element 126 of an embodiment of a battery module 100 shown in FIG. 15 substantially in that the intermediate element 168 designed as a compressible compensation element 170 has a maximum thickness 172 parallel to the stacking direction 104 of the battery module 100, which thickness is smaller than a maximum thickness 146 of the frame element 134, in particular of the supporting webs 140 of the frame element 134.

Otherwise, the spacer element 126 shown in FIG. 16 of the embodiment of a battery module 100 corresponds in terms of structure and function to the spacer element 126 shown in FIG. 15 of an embodiment of a battery module 100, such that reference is made to the above description thereof.

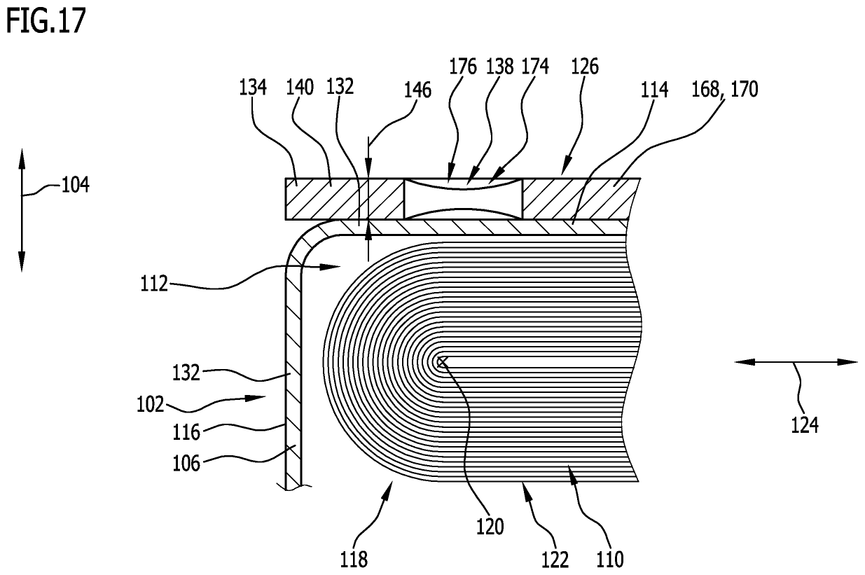

A spacer element 126 shown in FIG. 17 of an embodiment of a battery module 100 differs from the spacer element 126 of an embodiment of a battery module 100 shown in FIGS. 1 to 5 substantially in that the frame element 134 is connected to the intermediate element 168 at least in some regions, in particular integrally.

Preferably, the frame element 134 is made in one piece with the intermediate element 168.

The spacer element 126, which comprises or forms the frame element 134 and the intermediate element 168, is preferably a one-piece injection molded component.

In particular, it is conceivable that the spacer element 126 has material weakening 176 in a connection region 174 in which the frame element 134 is integrally connected to the intermediate element 168.

Otherwise, the spacer element 126 shown in FIG. 17 of the embodiment of a battery module 100 corresponds in terms of structure and function to the spacer element 126 shown in FIGS. 1 to 5 of an embodiment of a battery module 100, such that reference is made to the above description thereof.

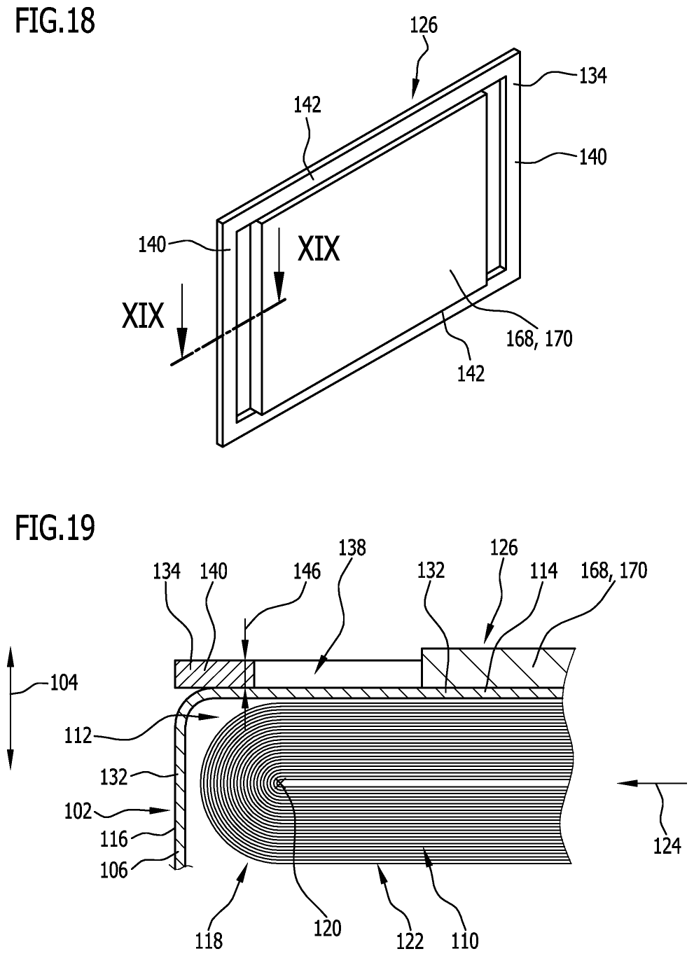

A spacer element 126 of an embodiment of a battery module 100 shown in FIGS. 18 and 19 differs from the spacer element 126 of an embodiment of a battery module 100 shown in FIGS. 13 and 14 substantially in that a projection of the intermediate element 168 along the stacking direction 104 onto a projection plane arranged perpendicular to the stacking direction 104 is at a distance from a projection of a respective common winding line 120 of a deflection region 118 of a cell winding 110 of a galvanic cell 102.

The projection of the intermediate element 168 is preferably at a distance parallel to the winding direction 124, in particular inward, from the projection of the common winding line 120.

Otherwise, the spacer element 126 shown in FIGS. 18 and 19 of the embodiment of a battery module 100 corresponds in terms of structure and function to the spacer element 126 shown in FIGS. 13 and 14 of an embodiment of a battery module 100, such that reference is made to the above description thereof.

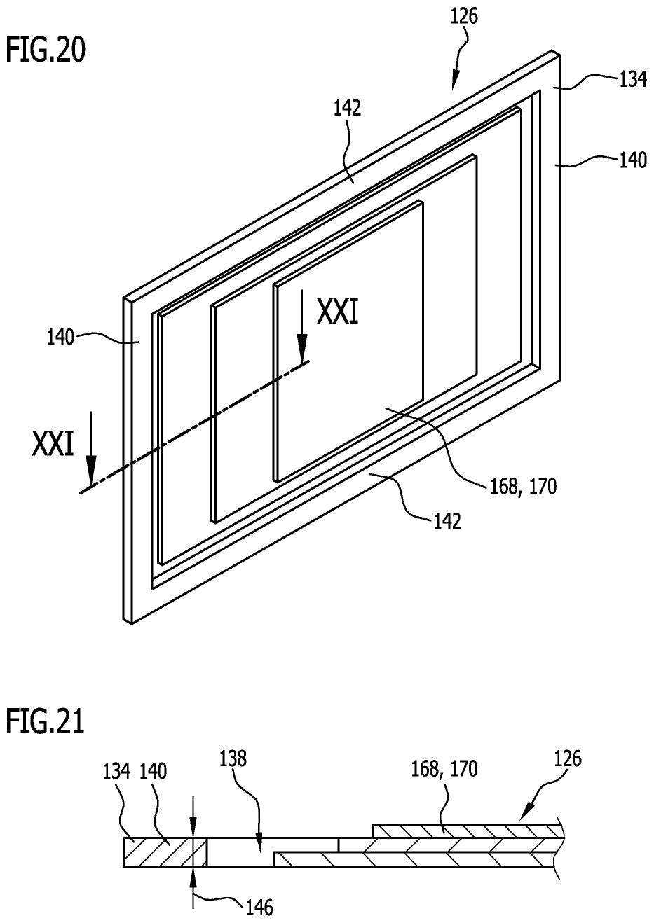

A spacer element 126 of an embodiment of a battery module 100 shown in FIGS. 20 and 21 differs from the spacer element 126 of an embodiment of a battery module 100 shown in FIGS. 13 and 14 substantially in that the intermediate element 168 designed as a compressible compensation element 170 is of multi-layer design in the stacking direction 104.

Preferably, different layers of the intermediate element 168 designed as a compressible compensation element 170 have a different surface area in a cross section taken perpendicularly to the stacking direction 104.

For example, the compensation element 170 has a stepped design.

In particular, the intermediate element 168 designed as a compensation element 170 can be adapted to a swelling behavior of two adjacent galvanic cells.

Otherwise, the spacer element 126 shown in FIGS. 20 and 21 of the embodiment of a battery module 100 corresponds in terms of structure and function to the spacer element 126 shown in FIGS. 13 and 14 of an embodiment of a battery module 100, such that reference is made to the above description thereof.

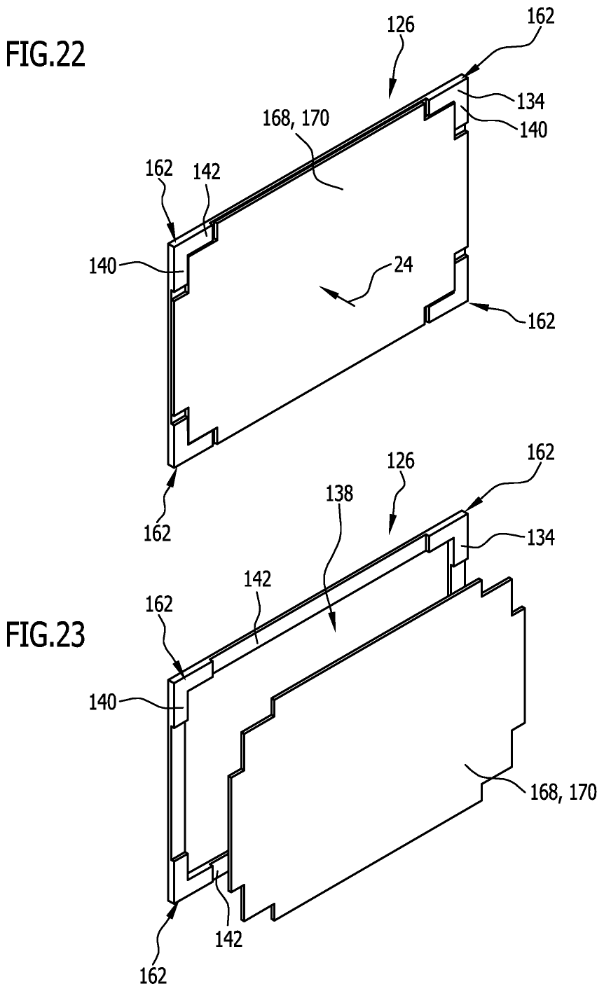

A spacer element 126 of an embodiment of a battery module 100 shown in FIGS. 22 to 26 differs from the spacer element 126 of an embodiment of a battery module 100 shown in FIGS. 13 and 14 substantially in that the intermediate element 168 is only in part arranged in the interior space 138.

The frame element 134 and the intermediate element 168 preferably overlap at least in part in the stacking direction 104.

The frame element 134 preferably corresponds to the frame element 134 shown in FIG. 10.

The intermediate element 168 preferably completely overlaps the frame element 134 with the exception of the corner regions 162 in which the supporting webs 140 and connecting webs 142 of the frame element 134 are connected to one another.

The intermediate element 168 preferably forms a compensation element 170, which can be compressed parallel to the stacking direction 104 of the battery module 100 (cf. FIG. 26).

In the regions in which the intermediate element 168 overlaps the frame element 134, the frame element 134 and the intermediate element 168 are preferably connected to one another in a force-fitting and/or form-fitting manner, in particular because the galvanic cells 102 are braced along the stacking direction 104.

Otherwise, the spacer element 126 shown in FIGS. 22 to 26 of the embodiment of a battery module 100 corresponds in terms of structure and function to the spacer element 126 shown in FIGS. 13 and 14 of an embodiment of a battery module 100, such that reference is made to the above description thereof.

A spacer element 126 shown in FIG. 27 of an embodiment of a battery module 100 differs from the spacer element 126 of an embodiment of a battery module 100 shown in FIGS. 22 to 26 substantially in that the frame element 134 and/or the intermediate element 168 in each case comprise or form a temperature control element 178.

It can be favorable here if the intermediate element 168 is designed to be non-compressible.

The frame element 134 and/or the intermediate element 168 are preferably designed for active temperature control and/or for passive temperature control.

By means of the frame element 134 and/or by means of the intermediate element 168, heat can preferably be dissipated from the two adjacent galvanic cells 102 between which the spacer element 126 is arranged.

In particular, it is conceivable that the two adjacent galvanic cells 102, between which the spacer element 126 is arranged, can be supplied with heat by means of the frame element 134 and/or by means of the intermediate element 168.

Preferably, the frame element 134 and/or the intermediate element 168 each comprise one or more heat-conducting elements 180 that protrude away from the frame element 134 and/or the intermediate element 168 in the stacking direction 104 of the battery module 100.

It can also be favorable if the frame element 134 and/or the intermediate element 168 have anisotropic thermal conductivity.

A thermal conductivity of the frame element 134 and/or of the intermediate element 168 in the stacking direction 104 of the battery module 100 is preferably less than a thermal conductivity of the frame element 134 and/or of the intermediate element 168 perpendicular to the stacking direction 104 of the battery module 100.

For example, it is conceivable that the frame element 134 and/or the intermediate element 168 is designed as a heat insulator in the stacking direction 104 of the battery module 100.

It can also be favorable if the frame element 134 and/or the intermediate element 168 are designed as heat conductors perpendicular to the stacking direction 104 of the battery module 100.

Otherwise, the spacer element 126 shown in FIG. 27 of the embodiment of a battery module 100 corresponds in terms of structure and function to the spacer element 126 shown in FIGS. 22 to 26 of an embodiment of a battery module 100, such that reference is made to the above description thereof.

A spacer element 126 of an embodiment of a battery module 100 shown in FIG. 28 differs from the spacer element 126 of an embodiment of a battery module 100 shown in FIGS. 1 to 5 substantially in that an edge region 182 of the spacer element 126, in particular an edge region 182 closed in a ring shape, is of multi-layer design.

The multi-layer edge region 182 preferably forms a frame element 134.

In particular, it is conceivable that the spacer element 126 comprises or is formed from a compressible material, for example a foam material.

The compressible material is, for example, elastically or plastically compressible.

It can be favorable if the compressible material in the multi-layer edge region 182 is consolidated by means of leveling and/or compacting

Otherwise, the spacer element 126 shown in FIG. 28 of the embodiment of a battery module 100 corresponds in terms of structure and function to the spacer element 126 shown in FIGS. 1 to 5 of an embodiment of a battery module 100, such that reference is made to the above description thereof.

A spacer element 126 of an embodiment of a battery module 100 shown in FIGS. 29 and 30 differs from the spacer element 126 of an embodiment of a battery module 100 shown in FIGS. 13 and 14 substantially in that the intermediate element 168 designed as a deformable compensation element 170 comprises a plurality of deformation elements 184.

In particular, the compensation element 170 comprises a plurality of deformation webs 186 that form the deformation elements 184.

The deformation webs 186 preferably have a U-shaped or V-shaped cross section.

A deformation web 186 of the compensation element 170 is preferably connected to two connecting webs 140 of the frame element 134 in each case.

In particular, it is conceivable that the deformation webs 186 are arranged substantially parallel to the supporting webs 140.

Otherwise, the spacer element 126 shown in FIGS. 29 and 30 of the embodiment of a battery module 100 corresponds in terms of structure and function to the spacer element 126 shown in FIGS. 13 and 14 of an embodiment of a battery module 100, such that reference is made to the above description thereof.

A spacer element 126 of an embodiment of a battery module 100 shown in FIGS. 31 and 32 differs from the spacer element 126 of an embodiment of a battery module 100 shown in FIGS. 29 and 30 substantially in that the intermediate element 168 designed as a deformable compensation element 170 comprises a plurality of deformable knobs 188 that form the deformation elements 184.

For the sake of clarity, only some of the deformable knobs 188 are identified with a reference sign in FIGS. 31 and 32.

The deformable knobs 188 are preferably substantially circular-cylindrical.

The deformable knobs 188 protrude away from a base plate 190, in particular parallel to the stacking direction 104 of the battery module 100, in particular on both sides of the base plate 190.

It can be favorable if one or more deformable knobs 188 have a different cross-sectional shape and/or a different diameter from one another, in particular in a cross section taken perpendicularly to the stacking direction 104 of the battery module 100.

The deformable knobs 188 are preferably arranged in a plurality of rows and/or a plurality of columns, in particular in alignment.

For example, it is conceivable that deformable knobs 188 arranged in a column each have an identical cross-sectional shape and/or an identical diameter.

Furthermore, it is conceivable, for example, that one or more deformable knobs 188 arranged in a row have a different cross-sectional shape and/or a different diameter from one another.

The intermediate element 168 designed as a deformable compensation element 170 can preferably be adapted to a swelling behavior of two adjacent galvanic cells 102.

In particular, a deformation resistance of the deformable knobs 188 can be adjusted by adjusting a diameter of said deformable knobs.

Otherwise, the spacer element 126 shown in FIGS. 31 and 32 of the embodiment of a battery module 100 corresponds in terms of structure and function to the spacer element 126 shown in FIGS. 29 and 30 of an embodiment of a battery module 100, such that reference is made to the above description thereof.

A spacer element 126 of an embodiment of a battery module 100 shown in FIGS. 33 and 34 differs from the spacer element 126 of an embodiment of a battery module 100 shown in FIG. 17 substantially in that the intermediate element 168 is not designed as a deformable and/or compressible compensation element 170.

The intermediate element 168 preferably has a locally varying thickness in a direction parallel to the stacking direction 104 of the battery module 100.

It can be favorable if the intermediate element 168 is connected to the frame element 134 only in the region of the two supporting webs 140 of said frame element.

The intermediate element 168 is preferably not connected to the frame element 134 in the region of the connecting webs 142 of said frame element.

Because the intermediate element 168 is preferably connected to the frame element 134 only in the region of the supporting webs 140, the intermediate element 168 is preferably connected to the frame element 134 in a resilient manner.

Otherwise, the spacer element 126 shown in FIGS. 33 and 34 of the embodiment of a battery module 100 corresponds in terms of structure and function to the spacer element 126 shown in FIG. 17 of an embodiment of a battery module 100, such that reference is made to the above description thereof.

A spacer element 126 of an embodiment of a battery module 100 shown in FIGS. 35 and 36 differs from the spacer element 126 of an embodiment of a battery module 100 shown in FIGS. 33 and 34 substantially in that the intermediate element 168 is connected to the frame element 134 closed in a ring shape.

In particular, the intermediate element 168 forms a cover element 192.

The cover element 192 preferably has a constant thickness 194 parallel to the stacking direction 104.

In particular, the cover element 192 has a thickness 194 parallel to the stacking direction 104, which thickness is smaller than a thickness 146 of the frame element 134.

Otherwise, the spacer element 126 shown in FIGS. 35 and 36 of the embodiment of a battery module 100 corresponds in terms of structure and function to the spacer element 126 shown in FIGS. 33 and 34 of an embodiment of a battery module 100, such that reference is made to the above description thereof.

An embodiment of a battery module 100 shown in FIG. 37 differs from the embodiment of a battery module 100 shown in FIG. 6 substantially in that the frame element parts 158 of the frame element 134 are substantially C-shaped.

One of the two C-shaped frame element parts 158 of the frame element 134 is preferably arranged on the opposing primary sides 114 of the cell housing 106 of the galvanic cell 102.

It can be favorable if the frame element parts 158 are connected, for example bonded, to the cell housing 106, in particular to the cell housing wall 132, on the opposing primary sides 114 of the cell housing 106.

The frame element parts 158 are preferably arranged and/or designed in such a way that projections of the frame element parts 158 arranged on the opposing primary sides 114 of the cell housing 106 of a galvanic cell 102 do not overlap parallel to the stacking direction 104 onto a plane arranged perpendicular to the stacking direction 104.

A positioning aid for positioning the galvanic cells 102 relative to one another can preferably be provided by the C-shaped frame element parts 158.

In particular, incorrect positioning of cell poles of two adjacent galvanic cells 102 can be prevented.

By stacking a plurality of galvanic cells 102, on whose opposing primary sides 114 C-shaped frame element parts 158 are arranged, the frame element parts 158 of the mutually facing primary sides 114 of two adjacent galvanic cells 102 preferably complement each other to form a frame element 134 closed in a ring shape.

Otherwise, the embodiment of a battery module 100 shown in FIG. 37 corresponds in terms of structure and function to the embodiment of a battery module 100 shown in FIG. 6, such that reference is made to the above description thereof.

An embodiment of a battery module 100 shown in FIG. 38 differs from the embodiment of a battery module 100 shown in FIGS. 1 to 5 substantially in that the spacer elements 126 are applied onto the cell housing 106 of the galvanic cell 102 with a castable, injectable and/or printable material 195.

For example, two bumps 197 are applied parallel to the common winding line 120 on a respective primary side 114 of the cell housing 106 of the galvanic cell 102.

Furthermore, it can be favorable if one or more knobs 188 are applied to a respective primary side 114 of the cell housing 106 of the galvanic cell 102.

The one or more spacer elements 126 are, in particular, made by means of a casting process, by means of a spraying process, and/or applied to the cell housing 106 of the galvanic cell 102 by means of a printing process.

Otherwise, the embodiment of a battery module shown in FIG. 38 corresponds in terms of structure and function to the embodiment of a battery module 100 shown in FIGS. 1 to 5, such that reference is made to the above description thereof.

An embodiment of a galvanic cell 102 shown in FIGS. 39 and 40 differs from the embodiment of a galvanic cell 102 shown in FIGS. 1 to 36 substantially in that the cell housing 106 of the galvanic cell 102 is not cuboid.

The cell housing 106 preferably comprises or forms one or more spacer elements 126.

In a battery module 100, which comprises a plurality of galvanic cells 102, two spacer elements 126 are preferably arranged between mutually facing cell windings 110 of two galvanic cells 102 that are adjacent in the stacking direction 104.

The cell housing 106 of the galvanic cells 102 preferably comprises a spacer region 196 and a central region 198 on each of the two primary sides 114 of the cell housing 116.

The spacer regions 196 preferably protrude away from the central region 196 perpendicular to a central plane of the cell windings 110 of the galvanic cells 102 and in each case form a spacer element 126.

The spacer regions 196 are preferably arranged on an edge region, in particular on an edge region closed in a ring shape, of a respective primary side 114 of the cell housing 106 of a galvanic cell 102.

The central region 198 of a respective primary side 114 is preferably surrounded by the spacer region 196 closed in a ring shape and in particular forms a depression in the primary side 114 of the cell housing 106 of the galvanic cell 102.

The cell housing 106 of a galvanic cell 102 is thus preferably substantially concave on the two primary sides 114.

A cell housing 106 of the galvanic cells 102 preferably comprises a transition region 200 on the two primary sides 114 that is arranged between the central region 198 and the spacer region 196.

Preferably, the spacer regions 196 comprise a surface that is arranged substantially parallel to a surface of the central region 198.

It can be favorable if the cell housing wall 132 of the cell housing 106 of the galvanic cells 102 rests against the cell winding 110 in the intermediate region 122 of a cell winding 110 of the galvanic cell 102.

In particular, it can be favorable if at least approximately 70%, in particular at least approximately 90%, of a surface of the intermediate region 122 of the cell winding 110 rests completely against the central region 198 of the cell housing wall 132.

The central region 198 of the cell housing wall 132 preferably rests substantially with its entire surface on the intermediate region 122 of the cell winding 110.

For example, it is conceivable that the cell housing wall 132 of the cell housing 106 of a galvanic cell 102 is arranged in the central region 198 substantially parallel to a central plane of a cell winding 110 of the galvanic cell 102.

The cell housing wall 132 of the cell housing 106 of a galvanic cell 102 preferably does not rest against the cell winding 110 in the deflection region 118 of a cell winding 110 of the galvanic cell 102.

It can be favorable if the cell housing wall 132 of the cell housing 106 of a galvanic cell 102 does not rest against a cell winding 110 of the galvanic cell 102 in the spacer region 196 and/or in the transition region 200.

In particular, the cell housing wall 132 of the cell housing 106 of a galvanic cell 102 is arranged in the spacer region 196 substantially parallel to a central plane of a cell winding 110 of the galvanic cell 102.

It can be favorable if the cell housing 106 of a galvanic cell 102 is substantially symmetrical, in particular substantially symmetrical with respect to a plane of symmetry arranged perpendicular to the stacking direction 104 of the battery module 100 and/or parallel to a central plane of a cell winding 110 of the galvanic cell 102.

The cell housing 106 of a galvanic cell is preferably substantially symmetrical with respect to a plane of symmetry arranged parallel to the stacking direction 104 of the battery module 100.

It can be favorable if the cell housing 106 of a galvanic cell 102 comprises or is formed by a metallic material, for example aluminum.

The cell housing 106 of a galvanic cell 102 is preferably what is referred to as a “hard case” housing.

The cell housing 106 is preferably produced by means of a forming process, for example by means of deep-drawing, and, in particular, has a substantially uniform wall thickness. It can be favorable here if spacer elements 126 formed by the cell housing 106 of the galvanic cell 102 are produced by means of a forming process.

The cell housings 106 of two adjacent galvanic cells 102 are preferably in direct contact with one another in the region of the spacer elements 126 formed by the cell housing 106 of the galvanic cells 102.

In particular, it can be favorable if the cell housings 106 of two adjacent galvanic cells 102 are only in direct contact with one another in some regions, in particular only in the region of the spacer elements 126 formed by the cell housing 106 of the galvanic cells 102.

The cell housing walls 132 of the cell housings 106 of two adjacent galvanic cells 102 are preferably arranged at a distance from one another by means of the spacer elements 126 formed by the cell housings 106 in an intermediate space 202 that is closed in a ring shape and delimited by the spacer elements 126.

In particular, the cell housing walls 132 of the cell housings 106 of two adjacent galvanic cells 102 are not in contact with one another in the intermediate space 202.

The central regions 198 and/or the transition regions 200 of a respective primary side 114 of the cell housings 106 of two adjacent galvanic cells 102 preferably delimit the intermediate space 202.

The intermediate space 202 is preferably formed between two adjacent galvanic cells 102 that are substantially concave on the mutually facing primary sides 114 of the cell housings 106.

It can be favorable if an additional element 204, for example a compensation element 206, a propagation protection element 208, a sensor element 209 and/or a temperature control element 210, is arranged in the intermediate space 202.

By means of a temperature control element 210 arranged in the intermediate space 202, the galvanic cells 102 adjacent to the intermediate space 202 can preferably be temperature-controlled, for example cooled.

In particular, heat can be dissipated from the intermediate space by means of a temperature control element 210 arranged in the intermediate space 202.

A temperature control element 210 arranged in the intermediate space 202 is preferably designed for active temperature control of the galvanic cells 102 adjacent to the intermediate space 202 and/or for passive temperature control of the galvanic cells 102 adjacent to the intermediate space 202.

Propagation of a thermal runaway of a galvanic cell 102 can preferably be delayed and/or prevented by means of a propagation protection element 208 arranged in the intermediate space 202.

A compensation element 206 arranged in the intermediate space 202 is deformable, for example compressible, in a direction parallel to the stacking direction 104 of the battery module 100, preferably due to an expansion of the cell housings 106 of two adjacent galvanic cells 102.

The compensation element 206 preferably comprises or is formed by a foam material.

A delamination of cell windings 110 of a respective galvanic cell 102 can preferably be limited or prevented by means of a compensation element 206 arranged in the intermediate space 202.

In a delivered state of the battery module 100, the cell housings 106 of two adjacent galvanic cells 102 are preferably prestressed in the stacking direction 104 of the battery module 100 by means of compensation elements 206 arranged in the intermediate space 202. Preferably, a prestressing force can thereby be realized that preferably counteracts an expansion of the cell housings 106 of the two adjacent galvanic cells 102, in particular due to aging.

Otherwise, the embodiment of the galvanic cell 102 shown in FIGS. 39 and 40 corresponds in terms of structure and function to the embodiment of a galvanic cell 102 shown in FIGS. 1 to 36, such that reference is made to the above description thereof.

An embodiment of a galvanic cell 102 shown in FIG. 41 differs from the embodiment of a galvanic cell 102 shown in FIGS. 39 and 40 substantially in that the cell housings 106 of a respective galvanic cell 102 are substantially concave on a primary side 114 and substantially convex on a primary side 114.

Furthermore, it is conceivable that the cell housings 106 are not produced by means of forming.

For example, it is conceivable that the cell housings 106 of the galvanic cells 102 are produced by means of extrusion.

Otherwise, the embodiment of the galvanic cell 102 shown in FIG. 41 corresponds in terms of structure and function to the embodiment of a galvanic cell 102 shown in FIGS. 39 and 40, such that reference is made to the above description thereof.

An embodiment of a galvanic cell 102 shown in FIG. 42 differs from the embodiment of a galvanic cell 102 shown in FIG. 41 substantially in that the cell housings 106 of the galvanic cells 102 are produced by means of an injection process, for example by means of an injection molding process, in particular from a plastic material.

It can be favorable if the cell housings 106 of the galvanic cells 102 are plastic components, in particular plastic injection molded components.

In particular, it is conceivable that two adjacent galvanic cells 102 are positioned or can be positioned in a unique alignment relative to one another in the stacking direction 104 of the battery module 100 by means of one or more spacer elements 126 formed by the cell housing 106 of the galvanic cells 102.

In particular, it is conceivable that mutually facing cell housing walls 132 of cell housings 106 of two adjacent galvanic cells 102 on the primary sides 114 of the cell housing 106 each comprise one or more projections or elevations designed as spacer elements 126 and recesses corresponding to the projections or elevations. For the sake of clarity, the projections or elevations and the recesses are not shown in FIG. 42.

Preferably, the projections or elevations and the recesses are arranged on the primary sides 114 of the cell housings 106 of two adjacent galvanic cells 102 such that the two galvanic cells 102 can only be positioned in one orientation relative to one another in the stacking direction 104 of the battery module 100.

Otherwise, the embodiment of the galvanic cell 102 shown in FIG. 42 corresponds in terms of structure and function to the embodiment of a galvanic cell 102 shown in FIG. 41, such that reference is made to the above description thereof.

An embodiment of a galvanic cell 102 shown in FIG. 43 differs from the embodiment of a galvanic cell 102 shown in FIGS. 1 to 36 substantially in that a compensation element 212 is arranged in the receiving space 112 of the cell housing 106.

The compensation element 212 is preferably arranged between two adjacent cell windings 110 of the galvanic cell 102.

The compensation element 212 is preferably compressible, in particular perpendicular to a primary side 114 of the cell housing 106 and/or perpendicular to a central plane of a cell winding 110 of the galvanic cell 102.

The compensation element 212 is preferably elastically or plastically compressible.

The compensation element 212 preferably comprises a compressible material or is formed from a compressible material.

The compressible material is a foam material, for example.

By providing the compensation element 212 in the receiving space 112 of the cell housing 106, a defined loading of the cell windings 110 of the galvanic cell 102 can preferably be implemented in any state of charge and/or in any state of aging of the galvanic cell 102.

In particular, by providing the compensation element 212 in the receiving space 112 of the cell housing 106, a loading on the cell windings 110 of a galvanic cell 102 can be implemented independently of one or more of the following factors:
a rigidity of the cell housing 106 of the galvanic cell 102;
clamping forces acting on the cell housing 106 of the galvanic cell 102, in particular clamping forces acting on the cell housing 106 parallel to the stacking direction 104 of a battery module 100;
growth of one or more cell windings 110 of the galvanic cell 102.

Growth of the cell windings 110 of the galvanic cell 102 over the service life of said galvanic cell can preferably be compensated for by means of the compensation element 212, in particular in a direction perpendicular to a primary side 114 of the cell housing 106.

Growth of the cell windings 110 of the galvanic cell 102 can preferably be compensated for by means of the compensation element 212 arranged in the cell housing 106 of the galvanic cell 102 in such a way that, at the end of the service life of the galvanic cell 102, the cell housing 106 of the galvanic cell 102 substantially has a height 148 in a direction perpendicular to a primary side 114 of the cell housing 106, which height corresponds to the height 148 of the cell housing 106 of the galvanic cell 102 in a delivered state of the galvanic cell 102.

A change in the external dimensions of the galvanic cell 102 due to growth of cell windings 110 of the galvanic cells 102 can preferably be limited or prevented by means of the compensation element 212.

In a delivered state of the galvanic cell 102, the compensation element 212 preferably has a thickness 214 perpendicular to a central plane of a cell winding 110 of galvanic cell 102 such that the compensation element 212 and cell windings 110 arranged inside the cell housing 106 substantially completely fill the receiving space 112 of the cell housing 106 perpendicular to the central plane of a cell winding 110 of the galvanic cell 102.

In particular, cavities inside the cell housing 106, in particular parallel to the stacking direction 104 of a battery module 100, can be prevented by means of the compensation element 212.

Furthermore, a delamination of the cell windings 110 of a galvanic cell 102 can preferably be limited or prevented.

It can also be favorable if an optimal operating state of the galvanic cell 102 can be adjusted over the entire product service life of said galvanic cell by means of the compensation element 212.

It can be favorable if the compensation element 212 has a width 216 parallel to the winding direction 124 of a cell winding 110 of the galvanic cell, which width corresponds at least approximately to the width of an intermediate region 122 of the cell winding 110.

In a direction parallel to a common winding line 120 of a cell winding 110, the compensation element 212 preferably has a height that substantially corresponds to a height of a cell winding 110 of the galvanic cell 106.

The cell windings 110 of a galvanic cell 102 preferably each have a substantially identical height in a direction parallel to a common winding line 120 of a cell winding 110.

Otherwise, the embodiment of the galvanic cell 102 shown in FIG. 43 corresponds in terms of structure and function to the embodiment of a galvanic cell 102 shown in FIGS. 1 to 36, such that reference is made to the above description thereof.

An embodiment of a galvanic cell 102 shown in FIG. 44 differs from the embodiment of a galvanic cell 102 shown in FIG. 43 substantially in that two compensation elements 212 are arranged in the receiving space 112 of the cell housing.

The compensation elements 212 are preferably arranged between a cell housing wall 132 of the cell housing 106 and a cell winding 110 of the galvanic cell 102, in particular in relation to a direction perpendicular to a central plane of a cell winding 110.

The compensation elements 212 are preferably in each case arranged between a cell housing wall 132 of a primary side 114 of the cell housing 106 and a cell winding 110 of the galvanic cell 102.

Otherwise, the embodiment of the galvanic cell 102 shown in FIG. 44 corresponds in terms of structure and function to the embodiment of a galvanic cell 102 shown in FIG. 43, such that reference is made to the above description thereof.

An embodiment of a galvanic cell 102 shown in FIG. 45 differs from the embodiment of a galvanic cell 102 shown in FIG. 43 substantially in that two compensation elements 212 are arranged in the receiving space 112 of the cell housing 106, which compensation elements are in each case arranged inside a cell winding 110 of the galvanic cell 102.

It can be favorable here if winding layers of a respective cell winding 110 are wound around a respective compensation element 212.

The compensation element 212 is preferably arranged substantially parallel to a central plane of the respective cell winding 110.

The compensation element 212 preferably has a width 216 parallel to the winding direction 124 of the cell winding 110, which width substantially corresponds to the width of the intermediate region 122 of the cell winding 110.

By winding winding layers of a respective cell winding 110 around a respective compensation element 212, it is preferably possible to prevent the winding layers from being deflected directly in the region of a common winding line 120.

In particular, a deflection radius can be enlarged by winding winding layers of a respective cell winding 110 around a respective compensation element 212.

A deflection radius in a deflection region 118 of a cell winding 110 is preferably at least approximately 0.5 mm, in particular at least approximately 1 mm, for example at least 1.5 mm.

In this way, a service life of the galvanic cell can preferably be lengthened.

It can also be favorable if growth of the respective cell winding 110, in particular in a direction perpendicular to a central plane of the cell winding 110, can be compensated for by means of the compensation element 212 arranged within a cell winding 110 such that, at the end of its service life, the galvanic cell 102 substantially has a height 148 in the direction perpendicular to the central plane of the cell winding 110, which height corresponds to the height of the galvanic cell 148 in a delivered state of said galvanic cell.

Otherwise, the embodiment of the galvanic cell 102 shown in FIG. 45 corresponds in terms of structure and function to the embodiment of a galvanic cell 102 shown in FIG. 43, such that reference is made to the above description thereof.

The following are particular embodiments:

### Embodiment 1

A galvanic cell (102) comprising:
   one or more cell windings (110);
   a cell housing (106) comprising a receiving space (122) for receiving the one or more cell windings (110),
   the one or more cell windings (110) being received in the receiving space (122) of the cell housing (106) and
   the cell housing (106) comprising or forming one or more spacer elements (126).

### Embodiment 2

The galvanic cell according to embodiment 1, characterized in that the cell housing (106) of the galvanic cell (102) comprises one or more spacer regions (196) and a central region (198) on a primary side (114) of the cell housing (106), in particular on both primary sides (114) of the cell housing (106), the one or more spacer regions (196) protruding away from the central region (198) perpendicular to a central plane of a cell winding (110) of the galvanic cell (102) and in each case forming a spacer element (126).

### Embodiment 3

The galvanic cell according to embodiment 1 or 2, characterized in that the one or more cell windings (110) of the galvanic cell (102) comprise two deflection regions (118), in which winding layers of the respective cell winding (110) are deflected, the winding layers having a common winding line (120) in a respective deflection region (118), and/or in that the one or more cell windings (110) of the galvanic cell (102) comprise an intermediate region (122) arranged between the two deflection regions (118).

### Embodiment 4

The galvanic cell according to embodiment 3, characterized in that a cell housing wall (136) of the cell housing (106) of the galvanic cell (102) rests against the cell winding (110) in the intermediate region (122) of a cell winding (110) of the galvanic cell (102).

### Embodiment 5

The galvanic cell according to embodiment 3 or 4, characterized in that a cell housing wall (132) of the cell housing (106) of the galvanic cell (102) does not rest against the cell winding (110) in the deflection region (118) of a cell winding (110) of the galvanic cell (102).

### Embodiment 6

The galvanic cell according to any of embodiments 2 to 5, characterized in that the one or more spacer regions (196) are arranged on an edge region, in particular on an edge region closed in a ring shape, of a respective primary side (114) of the cell housing (106) of a respective galvanic cell (106).

### Embodiment 7

The galvanic cell according to any of embodiments 1 to 6, characterized in that the cell housing (106) of the galvanic cell (102) is substantially concave on both primary sides (114).

### Embodiment 8

The galvanic cell according to any of embodiments 1 to 6, characterized in that the cell housing (106) of the galvanic cell (102) is substantially concave on a primary side (114) and substantially convex on a primary side (114).

### Embodiment 9

The galvanic cell according to any of embodiments 1 to 8, characterized in that the cell housing (106) of the galvanic cell (102) comprises or is formed by a metallic material, for example aluminum.

### Embodiment 10

A battery module (100), comprising two or more than two galvanic cells (102) according to any of embodiments 1 to 9.

### Embodiment 11

The battery module (100) according to embodiment 10, characterized in that the cell housings (106) of two adjacent galvanic cells (102) are in direct contact with one another in the region of the spacer elements (126) formed by the cell housing (106) of the galvanic cells (102).

### Embodiment 12

The battery module (100) according to embodiment 10 or 11, characterized in that cell housings (106) of two adjacent galvanic cells (102) are designed in such a way that cell housing walls (132) of the two adjacent galvanic cells (102) are arranged at a distance from one another by means of the spacer elements (126) formed by the cell housings (106) in an intermediate space (202) that is closed at least in portions, preferably in a ring shape, and that is delimited by the spacer elements (126).

### Embodiment 13

The battery module according to embodiment 12, characterized in that one or more additional elements (204) are arranged in the intermediate space (202), for example one or more compensation elements (206), one or more propagation protection elements (208), one or more sensor elements (209) and/or one or more temperature control elements (210).

### Embodiment 14

The battery module according to any of claims 10 to 13, characterized in that two adjacent galvanic cells (102) are positioned or can be positioned in a unique alignment relative to one another in a stacking direction (104) of the battery module (100) by means of one or more spacer elements (126) formed by the cell housing (106) of the galvanic cells (102).

### Embodiment 15

A galvanic cell (102) comprising:
   one or more cell windings (110);
   a cell housing (106) comprising a receiving space (112) for receiving the one or more cell windings (110);
   one or more compensation elements (212),
the one or more cell windings (110) being received in the receiving space (112) of the cell housing (106) and
the one or more compensation elements (212) being arranged in the receiving space (112) of the cell housing (106).

### Embodiment 16

The galvanic cell according to embodiment 15, characterized in that the one or more compensation elements (212) can be compressed, in particular perpendicularly to a primary side (114) of the cell housing (106) and/or perpendicularly to a central plane of a cell winding (110) of the galvanic cell (102).

### Embodiment 17

The galvanic cell according to embodiment 15 or 16, characterized in that, in a delivered state of the galvanic cell (102), the one or more compensation elements (212) have a thickness (214) perpendicular to a central plane of a cell winding (110) of the galvanic cell (102) such that the one or more compensation elements (212) arranged inside the cell housing (106) of the galvanic cell (102) and cell windings (110) arranged inside the cell housing (106) substantially completely fill a receiving space (112) of the cell housing perpendicularly to the central plane of the cell winding (110) of the galvanic cell (102).

### Embodiment 18

The galvanic cell according to any of embodiments 15 to 17, characterized in that the one or more compensation elements (212) comprise a compressible material or are formed from a compressible material.

### Embodiment 19

The galvanic cell according to embodiment 18, characterized in that the compressible material is a foam material.

### Embodiment 20

The galvanic cell according to any of embodiments 15 to 19, that one or more of the compensation elements (212) arranged in the receiving space (112) of the cell housing (106) are arranged between two adjacent cell windings (110) of the galvanic cell (102).

### Embodiment 21

The galvanic cell according to any of embodiments 15 to 20, characterized in that one or more of the compensation elements (212) arranged in the receiving space (112) of the cell housing (106) are arranged between a cell housing wall (136) of the cell housing (106) and a cell winding (110) of the galvanic cell (102), in particular in relation to a direction perpendicular to a central plane of the cell winding (110).

### Embodiment 22

The galvanic cell according to any of embodiments 16 to 21, characterized in that one or more compensation elements (212) are arranged between the cell housing walls (132) of two primary sides (114) of the cell housing (106) of the galvanic cell (102) and one or more cell windings (110) arranged inside the cell housing (106).

### Embodiment 23

The galvanic cell according to any of embodiments 20 to 22, characterized in that a compensation element (212) arranged between two adjacent cell windings (110) of the galvanic cells (102) and/or a compensation element (212) arranged between a cell housing wall (132) of the cell housing (106) and a cell winding (110) of the galvanic cell (102) has a width (216) parallel to a winding direction (124) of the cell winding (110) that at least approximately corresponds to the width of an intermediate region (122) of the cell winding (110).

### Embodiment 24

The galvanic cell according to any of embodiments 15 to 24, characterized in that one or more of the compensation elements (212) arranged in the receiving space (112) of the cell housing (106) are arranged inside one or more cell windings (110) of the galvanic cell (102).

### Embodiment 25

The galvanic cell according to embodiment 24, characterized in that a compensation element (212) of the galvanic cell (102) arranged inside a cell winding (110) is arranged substantially parallel to a central plane of the respective cell winding (110).

### Embodiment 26

The galvanic cell according to embodiment 24 or 25, characterized in that a compensation element (212) of the galvanic cell (102) arranged inside a cell winding (110) has a width (216) parallel to a winding direction (124) of the cell winding (110) that substantially corresponds to the width of an intermediate region (122) of the cell winding (110).

### Embodiment 27

The galvanic cell according to any of embodiments 15 to 26, characterized in that one or more of the compensation elements (212) arranged in the receiving space (112) of the cell housing (106) have a height in a direction parallel to a common winding line (120) of a cell winding (110), which height substantially corresponds to a height of the one or more cell windings (110) of the galvanic cell (102).

### Embodiment 28

A battery module (100), the battery module (100) comprising:
two or more than two galvanic cells (102) according to any of embodiments 15 to 27.

### Embodiment 29

A battery module (100), the battery module (100) comprising:
   two or more than two galvanic cells (102), each comprising one or more cell windings (110);
      one or more spacer elements (126),
in each case one or more spacer elements (126) being arranged between two adjacent galvanic cells (102).

### Embodiment 30

The battery module according to embodiment 29, characterized in that a respective cell winding (110) of the galvanic cells (102) of the battery module (100) comprises two deflection regions (118), in which winding layers of the respective cell winding (110) are deflected, the winding layers having a common winding line (120) in a respective deflection region (118).

### Embodiment 31

The battery module according to embodiment 30, characterized in that the one or more spacer elements (126) are each arranged and/or designed in such a way that, in a stacking direction (104) of the battery module (100), an introduction of force into the one or more cell windings (110) of a respective galvanic cell (102) can be avoided by means of the spacer elements (126), in particular in the region of a winding line (120) of a respective deflection region (118) of the one or more cell windings (110).

### Embodiment 32

The battery module according to any of embodiments 29 to 31, characterized in that a force flows between adjacent galvanic cells (102) in a stacking direction (104) of the battery module (100) exclusively or to an extent of at least approximately 75%, in particular to an extent of at least approximately 85%, preferably to an extent of at least approximately 95%, via the one or more spacer elements (126).

### Embodiment 33

The battery module according to any of embodiments 29 to 32, characterized in that the galvanic cells (102) are prismatic cells, in particular substantially cuboid cells.

### Embodiment 34

The battery module according to any of embodiments 29 to 33, characterized in that a respective galvanic cell (102) comprises a cell housing (106) in which the one or more cell windings (110) of a respective galvanic cell (102) are arranged.

### Embodiment 35

The battery module according to any of embodiments 29 to 34, characterized in that one or more spacer elements (126) are respectively arranged between the cell housings (106) of two adjacent galvanic cells (102).

### Embodiment 36

The battery module according to embodiment 35, characterized in that one or more spacer elements (126), which are arranged between cell housings (106) of two adjacent galvanic cells (102), are arranged on a primary side (114) of the respective cell housing (106).

### Embodiment 37

The battery module according to embodiment 35 or 36, characterized in that one or more spacer elements (126) arranged between two cell housings (106) of two adjacent galvanic cells (102) each comprise or form a frame element (134) and/or an intermediate element (168).

### Embodiment 38

The battery module according to embodiment 37, characterized in that a respective frame element (134) delimits an interior space (138) surrounded by the frame element (134) and the two adjacent cell housings (106) at least in some regions, for example at least on two sides.

### Embodiment 39

The battery module according to embodiment 37 or 38, characterized in that a respective frame element (134) comprises the following:
   two supporting webs (140), which are arranged parallel to one another and/or parallel to a common winding line (120) of a deflection region (118) of a cell winding (110) of a galvanic cell (102); and/or
   one or more connecting webs (142), the two supporting webs (140) being connected by means of the one or more connecting webs (142).

### Embodiment 40

The battery module according to any of embodiments 37 to 39, characterized in that a respective frame element (134) is designed to be closed in a ring shape.

### Embodiment 41

The battery module according to embodiment 39 or 40, characterized in that the two supporting webs (140) and/or the one or more connecting webs (142) have a substantially constant width (144) transversely, in particular perpendicularly, to a main direction of extent thereof.

### Embodiment 42

The battery module according to embodiment 41, characterized in that the width (144) of the two supporting webs (140) substantially corresponds to the width (144) of the one or more connecting webs (142).

### Embodiment 43

The battery module according to embodiment 41, characterized in that the width (144) of the two supporting webs (140) differs from the width (144) of the one or more connecting webs (142).

### Embodiment 44

The battery module according to any of embodiments 41 to 43, characterized in that the width (144) of the two supporting webs (140) corresponds approximately to a sum of a wall thickness (152) of a cell housing wall (132) of a cell housing (106) of a galvanic cell (102), a distance (150) of a cell winding (110) from the cell housing wall (132) of the cell housing (106) and a width (154) of a deflection region (118) of a cell winding (110).

### Embodiment 45

The battery module according to any of embodiments 39 to 44, characterized in that a projection of a respective supporting web (140) of a frame element (134), in particular a region of the supporting web (140) abutting a cell housing (106) of a galvanic cell (102), along the stacking direction (104) onto a projection plane arranged perpendicular to the stacking direction (104) is at a distance from a projection of a respective common winding line (120) of a deflection region (118) of a cell winding (110) of a galvanic cell (102).

### Embodiment 46

The battery module according to any of embodiments 39 to 45, characterized in that the supporting webs (140) of the frame element (134) and/or the connecting webs (142) of the frame element (134) have a constant thickness (146) in a direction parallel to a stacking direction (104) of the battery module (100).

### Embodiment 47

The battery module according to any of embodiments 39 to 45, characterized in that the supporting webs (140) of the frame element (134) and/or the connecting webs (142) of the frame element (134) have a locally varying thickness (146) in a direction parallel to a stacking direction (104) of the battery module (100).

### Embodiment 48

The battery module according to any of embodiments 38 to 47, characterized in that the intermediate element (168) is arranged in the interior space (138).

### Embodiment 49

The battery module according to any of embodiments 37 to 48, characterized in that the frame element (134) is designed in one or more parts, for example in two parts.

### Embodiment 50

The battery module according to any of embodiments 37 to 49, characterized in that two spacer elements (126), in particular two frame elements (134), are arranged between cell housings (106) of two adjacent galvanic cells (102).

### Embodiment 51

The battery module according to any of embodiments 37 to 50, characterized in that the frame element (134) is connected to the intermediate element (168) at least in some regions, in particular integrally.

### Embodiment 52

The battery module according to any of embodiments 37 to 51, characterized in that the frame element (134) and the intermediate element (168) comprise materials that differ from one another or are formed from materials that differ from one another.

### Embodiment 53

The battery module according to any of embodiments 37 to 52, characterized in that the intermediate element (168) forms a deformable compensation element (170).

### Embodiment 54

The battery module according to embodiment 53, characterized in that the compensation element (170) can be compressed parallel to a stacking direction (104) of the battery module (100).

### Embodiment 55

The battery module according to embodiment 53 or 54, characterized in that the compensation element (170) comprises one or more deformation elements (184).

### Embodiment 56

The battery module according to any of embodiments 37 to 55, characterized in that an edge region (182) of a spacer element (126), in particular an edge region (182) closed in a ring shape, is of multi-layer design, the multi-layer edge region (182) forming a frame element (134).

### Embodiment 57

The battery module according to any of embodiments 37 to 56, characterized in that a respective spacer element (126), in particular a respective frame element (134) and/or a respective intermediate element (168), comprises or is formed from a metallic material, a paper material or a plastic material.

### Embodiment 58

The battery module according to any of embodiments 37 to 57, characterized in that a force flows between adjacent galvanic cells (102) in a stacking direction (104) of the battery module (100) exclusively or to an extent of at least approximately 75%, in particular to an extent of at least approximately 85%, preferably to an extent of at least approximately 95%, via the frame element (134) of the one or more spacer elements (126).

### Embodiment 59

The battery module according to any of embodiments 35 to 58, characterized in that a spacer element (126), in particular a frame element (134), arranged between the cell housings (106) of two adjacent galvanic cells (102) is in each case integrally connected, in particular bonded, to the cell housings (106) of the two adjacent galvanic cells (102).

### Embodiment 60

The battery module according to embodiment 59, characterized in that the spacer element (126), in particular a frame element (134) of the spacer element (126), arranged between the cell housings (106) of two adjacent galvanic cells (102) is in each case bonded to the cell housings (106) of the two adjacent galvanic cells (102) by means of an adhesive film (136), which is in each case arranged between a primary side (114) of a cell housing (106) of a respective galvanic cell (102) and the spacer element (126), in particular the frame element (134).

### Embodiment 61

The battery module according to any of embodiments 35 to 60, characterized in that all spacer elements (126) of the battery module (100) arranged between two cell housings (106) of two adjacent galvanic cells (102) are of identical design.

### Embodiment 62

The battery module according to any of embodiments 37 to 61, characterized in that the frame element (134) and/or the intermediate element (168) each comprise or form a temperature control element (178).

### Embodiment 63

The battery module according to any of embodiments 29 to 62, characterized in that the battery module (100) comprises a battery module housing in which the galvanic cells (102) of the battery module are arranged.

### Embodiment 64

A method for attaching spacer elements (126) to a galvanic cell (102), the method comprising:
   providing a galvanic cell (102) comprising one or more cell windings (110);
   applying one or more spacer elements (126) made of a castable, injectable and/or printable material (195) to a cell housing (106) of the galvanic cell (102).

### Embodiment 65

The method according to embodiment 64, characterized in that the one or more spacer elements (126) are applied to the cell housing of the galvanic cell (102) by means of one or more of the following application methods:
   by means of a casting process;
   by means of an injection process;
   by means of a printing process.

### Embodiment 66

The method according to embodiment 65, characterized in that the one or more spacer elements (102) are applied to the cell housing (106) of the galvanic cell (102) by means of one or more of the following printing processes:
   by means of a screen printing process;
   by means of a stencil printing process.

### Embodiment 67

The method according to any of embodiments 64 to 66, characterized in that the castable, injectable and/or printable material (195) comprises a base material and spacer particles arranged in the base material.

### Embodiment 68

The method according to any of embodiments 64 to 67, characterized in that one or more propagation protection elements (208) and/or one or more compensation elements (170) made of a castable, injectable and/or printable material (195) are applied to the cell housing (106) of the galvanic cell (102).

### Embodiment 69

The method according to any of embodiments 64 to 68, characterized in that the one or more spacer elements (126) are applied to the cell housing (106) of the galvanic cell (102) using an application device.

### Embodiment 70

The method according to any of embodiments 64 to 69, characterized in that the one or more spacer elements (126) are applied to the cell housing (106) of the galvanic cell (102) with a locally varying thickness.

### Embodiment 71

The method according to any of embodiments 64 to 70, characterized in that the one or more spacer elements (126) are applied directly or indirectly to the cell housing (106) of the galvanic cell (102).

### Embodiment 72

The method according to any of embodiments 64 to 71, characterized in that a plurality of layers of the castable, injectable and/or printable material (195) are applied to the cell housing (106) of the galvanic cell (102) one after the other.

### Embodiment 73

The method according to any of embodiments 64 to 72, characterized in that the castable, injectable and/or printable material (195) comprises or is formed by polyurethane and/or silicone.

### Embodiment 74

The method according to any of embodiments 64 to 73, characterized in that a bump (197) and/or knobs (188) are applied to, for example sprayed onto, the cell housing (106) of the galvanic cell (102) as spacer elements (126).

### Embodiment 75

The method according to any of embodiments 64 to 74, characterized in that the castable, injectable and/or printable material ( ) is applied to the cell housing (106) of the galvanic cell (102) through a template.

### Embodiment 76

A method for producing a battery module (100), the method comprising:
providing two or more than two galvanic cells (102) to which spacer elements (126) are attached by means of a method according to any of embodiments 64 to 75;
stacking the galvanic cells (102) along a stacking direction (104).

Overall, galvanic cells 102 and/or battery modules 100 comprising several galvanic cells 102, which have an increased service life and which are in particular easy and inexpensive to manufacture, can be provided.

1. A method for attaching spacer elements to a galvanic cell, the method comprising:
providing a galvanic cell comprising one or more cell windings;
applying one or more spacer elements made of a castable, injectable and/or printable material to a cell housing of the galvanic cell.

2. The method according to claim 1, wherein the one or more spacer elements are applied to the cell housing of the galvanic cell by means of one or more of the following application methods:
by means of a casting process;
by means of an injection process;
by means of a printing process.

3. The method according to claim 2, wherein the one or more spacer elements are applied to the cell housing of the galvanic cell by means of one or more of the following printing processes:
by means of a screen printing process;
by means of a stencil printing process.

4. The method according to claim 1, wherein the castable, injectable and/or printable material comprises a base material and spacer particles arranged in the base material.

5. The method according to claim 1, wherein one or more propagation protection elements and/or one or more compensation elements made of a castable, injectable and/or printable material are applied to the cell housing of the galvanic cell.

6. The method according to claim 1, wherein the one or more spacer elements are applied to the cell housing of the galvanic cell using an application device.

7. The method according to claim 1, wherein the one or more spacer elements are applied to the cell housing of the galvanic cell with a locally varying thickness.

8. The method according to claim 1, wherein the one or more spacer elements are applied directly or indirectly to the cell housing of the galvanic cell.

9. The method according to claim 1, wherein a plurality of layers of the castable, injectable and/or printable material are applied to the cell housing of the galvanic cell one after the other.

10. The method according to claim 1, wherein the castable, injectable and/or printable material comprises or is formed by polyurethane and/or silicone.

11. The method according to claim 1, wherein a bump and/or knobs are applied to, for example sprayed onto, the cell housing of the galvanic cell as spacer elements.

12. The method according to claim 1, wherein the castable, injectable and/or printable material is applied to the cell housing of the galvanic cell through a template.

13. A method for producing a battery module, the method comprising:
providing two or more than two galvanic cells to which spacer elements are attached by means of a method according to claim 1;
stacking the galvanic cells along a stacking direction.
